(19) United States
(12) Patent Application Publication
(10) Pub. No.: US 2006/0092120 A1
(43) Pub. Date: May 4, 2006

(54) Liquid crystal display device and method for driving the same

(75) Inventor: Takashi Nose, Kawasaki (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KAWASAKI (JP)

(21) Appl. No.: 11/259,065

(22) Filed: Oct. 27, 2005

(30) Foreign Application Priority Data
Oct. 28, 2004 (JP) 2004-314227

(51) Int. Cl. G09G 3/36

(52) U.S. Cl. 345/98

(57) ABSTRACT

A liquid crystal display device includes a controlling unit. The controlling unit is configured to control a liquid crystal panel. The controlling unit includes an image judging unit and a method determining unit. The image judging unit is configured to compare a gradation of each pixel of image data with a reference gradation. The method determining unit is configured to determine an inversion driving method for displaying the image data on the liquid crystal panel every plurality of pixels of less than one frame in the image data as a selection inversion driving method, based on the comparison result.

### BACKGROUND OF THE INVENTION

1. Field of the Invention

The present invention relates to a liquid crystal display device, and more particularly relates to a method for driving the same.

2. Description of the Related Art

In recent years, a large liquid crystal panel of 30 inches or more has been developed as a liquid crystal display device for TV. Also, to reduce a cost of the liquid crystal display device, it is considered that the number of the data driving units is to be reduced by increasing the number of the output terminals of one data driving unit.

In conjunction with the above description, Japanese Laid Open Patent Application JP 2003-337577A discloses the technique for a liquid crystal display device and a method for driving the same. This method for driving the liquid crystal display device includes first to third stages. The first stage drives the liquid crystal display device by using a first dot inversion method where the set polarities of adjacent pixels are opposite to each other. The second stage judges whether or not the pattern, where the gradation difference between adjacent two same color pixels in the continuous predetermined number of the pixels exceeds a predetermined range, occupies a predetermined region or more in the entire pixels. The third stage converts the first dot inversion method into a second dot inversion method, if the pattern occupies the predetermined region or more. The second dot inversion method may be the method of assuming the adjacent two gate lines respectively linked to the adjacent two pixels to be one set of gate lines and alternately inverting the polarities set for the gate lines for each set.

As the liquid crystal panel is getting larger, the electric power consumption and the number of the output terminals of the data driving unit are increased. This leads to the increase in the heating value of the data driving unit. Thus, as the method for driving the liquid crystal panel, it becomes difficult to employ a dot inversion driving method whose image quality is excellent, but its electric power consumption is high. However, there is a possibility that the reduction in the number of the inversions causes the image quality to be deteriorated such as the generation of flicker. The liquid crystal display device for reducing the electric power consumption and the heat generation and suppressing the generation of the flicker, and the method for driving the same are desired.

### SUMMARY OF THE INVENTION

It is therefore an object of the present invention to provide a liquid crystal display device that can reduce the electric power consumption while suppressing the deterioration in an image quality and a method for driving the same.

In order to achieve an aspect of the present invention, the present invention provides a liquid crystal display device including: a controlling unit configured to control a liquid crystal panel, wherein said controlling unit includes: an image judging unit configured to compare a gradation of each pixel of image data with a reference gradation, and a method determining unit configured to determine an inversion driving method for displaying said image data on said liquid crystal panel every plurality of pixels of less than one frame in said image data as a selection inversion driving method, based on said comparison result.

In the present invention, the inversion driving method is selected and changed based on the gradation of the image data. Therefore, the appropriate inversion driving method, in which the image deterioration is suppressed and the electric power consumption is low, can be used during displaying the image data. That is, for example, in the gradation region where the high voltage is required for the charging/discharging, the inversion driving method, in which the number of the polarity inversions is small, can be selected to reduce the electric power consumption. In the gradation region where it is easy to see the flicker, the inversion driving method, of which image quality is excellent, can be selected to suppress the deterioration of the displayed image data.

According to the present invention, it is possible to reduce the electric power consumption while suppressing the deterioration in the image quality such as the generation of the flicker, and suppress the heat generation.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing a configuration of the first embodiment of the liquid crystal display device according to the present invention;

FIG. 2 is a graph showing a concept of the liquid crystal display device and the method of driving the same of the present invention;

FIG. 3 is a flowchart showing an operation of the first embodiment of the liquid crystal display device according to the present invention;

FIG. 4 is a conceptual view showing a voltage polarity applied to the liquid crystal panel in the present invention;

FIG. 5 is a block diagram showing a gate driving unit in the liquid crystal display device of the present invention;

FIGS. 6A to 6C are block diagrams showing examples of switch controls in respective circuits;

FIGS. 7A to 7H are timing charts showing an operation of respective circuits shown in FIG. 5;

FIG. 8 is a block diagram showing a configuration of the second embodiment of the liquid crystal display device of the present invention;

FIG. 9 is a conceptual view showing a voltage polarity applied to a liquid crystal panel in the present invention;

FIG. 10 is a block diagram showing a configuration of the inversion switching position storage memory;

FIG. 11 is a block diagram showing configurations of a data line driving circuit and reference voltage generating unit;

FIGS. 12A to 12D are timing charts showing operations of respective circuits shown in FIG. 8;

FIG. 13 is a block diagram showing a configuration of the third embodiment of the liquid crystal display device according to the present invention;

FIG. 14 is a conceptual view showing a voltage polarity applied to a liquid crystal panel in the present invention;

FIG. 15 is a block diagram showing a gate driving unit in the liquid crystal display device of the present invention;

FIGS. 16 to 21 are block diagrams showing the examples of switch controls in respective circuits; and

FIGS. 22A to 220 are timing charts showing operations of respective circuits shown in FIG. 15.

### DESCRIPTION OF THE PREFERRED EMBODIMENTS

Embodiments of a liquid crystal display device and a method for driving the same of the present invention will be described below with reference to the attached drawings.

### First Embodiment

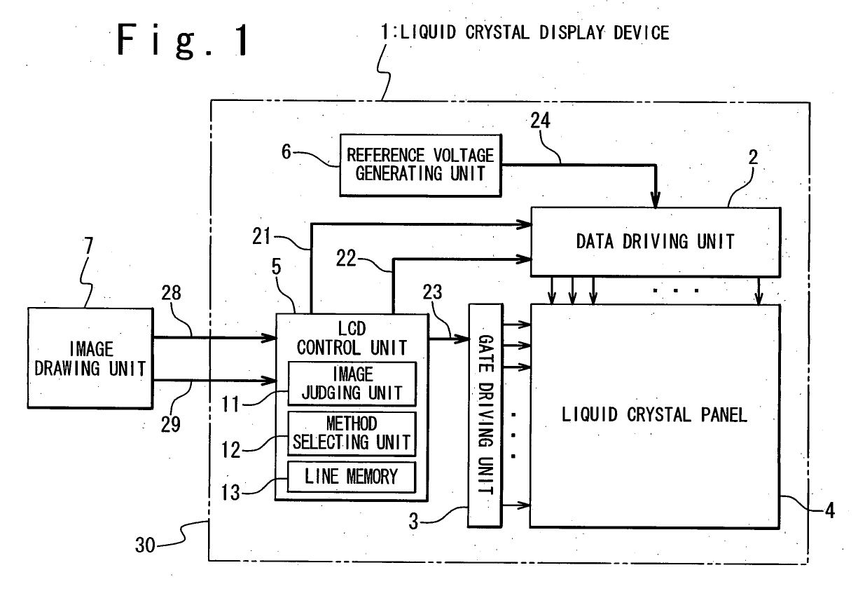

At first, the configuration of the first embodiment of the liquid crystal display device according to the present invention will be explained. FIG. 1 is a block diagram showing the configuration of the first embodiment of the liquid crystal display device according to the present invention. A liquid crystal display device 1 includes a data driving unit 2, a gate driving unit 3, a liquid crystal panel 4, an LCD control unit 5 and a reference voltage generating unit 6.

The LCD control unit 5 receives an input image data 28 and a display control signal 29 from an image drawing unit 7 (for example, CPU). The input image data 28 includes a gradation data (RGB signal) of each pixel. The display control signal 29 includes a vertical synchronization signal, a horizontal synchronization signal, a clock signal and a data enable signal. Then, based on the input image data 28 and the display control signal 29, the LCD control unit 5 outputs an image data 21 and a data-side control signal 22 to the data driving unit 2, and a gate-side control signal 23 to the gate driving unit 3, respectively. The data-side control signal 22 includes a control signal for selecting one from a 2H dot inversion driving method and a dot inversion driving method every plurality of pixels of less than one frame, in addition to the normal data-side control signal. The gate-side control signal 23 includes the normal gate-side control signal.

The LCD control unit 5 includes an image judging unit 11, a method selecting unit 12 and a line memory 13.

The image judging unit 11 compares the gradation of the input image data 28 with a setting gradation for each pixel in the input image data 28, and judges whether the gradation of the input image data 28 is higher or lower than the setting gradation. The compared result (judged result) is outputted to the method selecting unit 12. The input image data 28 is outputted to the line memory 13.

The method selecting unit 12 selects the inversion driving method when input image data are displayed on the liquid crystal panel 4, for every plurality of pixels of less than one frame, based on the compared result. The “plurality of pixels of the less than one frame” (hereinafter, also referred to as a “predetermined pixels”) is exemplified as the “pixels corresponding to the plurality of lines” (hereinafter, also referred to as a “predetermined lines”), such as the pixels corresponding to 4 lines. The pixels corresponding to 4 lines are the pixels included in 4 lines. The selecting method is carried out, for example, as follows.

For example, when the liquid crystal panel is a normally white type panel, if the number (rate) of the pixels, each of which the gradation of the input image data 28 is lower (a transmission rate is lower) than or equal to the setting gradation, is equal to or more the predetermined number (rate) among the predetermined pixels, the 2H dot inversion driving method is selected to be used. If the number (rate) of the pixels, each of which the gradation of the input image data 28 is higher (a transmission rate is higher) than the setting gradation, is equal to or more the predetermined number (rate) among the predetermined pixels, the dot inversion driving method is selected to be used.

On the other hand, when the liquid crystal panel is a normally black type panel, if the number (rate) of the pixels, each of which the gradation of the input image data 28 is higher (a transmission rate is higher) than or equal to the setting gradation, is equal to or more the predetermined number (rate) among the predetermined pixels, the 2H dot inversion driving method is selected to be used. If the number (rate) of the pixels, each of which the gradation of the input image data 28 is lower (a transmission rate is lower) than the setting gradation, is equal to or more the predetermined number (rate) among the predetermined pixels, the dot inversion driving method is selected to be used.

That is, it is selected such that the number of the inversions of the gradation region where the high voltage is applied to the liquid crystal panel is small. The predetermined number is determined by a design. For example, it is one (1).

The line memory 13 transiently stores the input image data 28 corresponding to the predetermined lines (pixels) for which the inversion driving method is selected by the method selecting unit 12. For example, in the case that the method selecting unit 12 selects the inversion driving method every pixels corresponding to the 4 lines, the input image data 28 corresponding to the 4 lines are stored. Then, after the input image data 28 corresponding to the plurality of lines are stored, the input image data 28 are outputted as the image data 21 to the line memory 13. The line memory 13 is provided to perform the timing adjustment between the image data 21 and the data-side control signal 22 that the judged result is reflected when the image data 21 is outputted to the line memory 13.

The reference voltage generating unit 6 generates reference gradation voltages 24, each of which corresponds to one of gradations of the input image data. The reference voltage generating unit 6 outputs the reference gradation voltages 24 to the data driving unit 2.

The gate driving unit 3 controls a plurality of gate lines of the liquid crystal panel 4, based on the gate-side control signal 23. However, it may be configured integrally with the LCD control unit 5. In that case, the circuit area can be reduced.

The data driving unit 2 controls a plurality of data lines of the liquid crystal panel 4, based on the image data 21, the data-side control signal 22 and the reference gradation voltages 24. However, it may be configured integrally with the LCD control unit 5. In that case, the circuit area can be reduced.

The liquid crystal panel 4 displays an image based on the controls of the plurality of gate lines by the data driving unit 2 and the plurality of data lines by the gate driving unit 3.

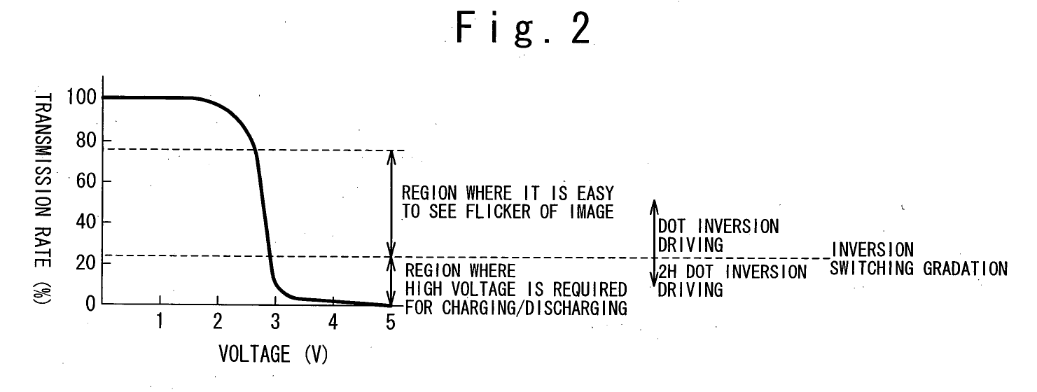

Here, the concept of the liquid crystal display device of the present invention and the method for driving the same are explained. The setting gradation in the image judging unit 11 is explained. FIG. 2 is a graph showing the concept of the liquid crystal display device and the method of driving the same of the present invention. This graph shows the voltage-transmission rate property of the liquid crystal in the liquid crystal panel 4. The vertical axis indicates the voltage applied to a certain pixel of the liquid crystal panel, and the horizontal axis indicates the transmission rate of light in the pixel. Here, the normally white type panel is explained as the example of the liquid crystal panel. The voltage-transmission rate property of the liquid crystal is sharply changed in the vicinity of an intermediate gradation (about 2 V to 3 V in FIG. 2). However, it is gently changed in the vicinity of white (about 0 V to 2 V) and black (about 3 V to 5 V). That is, in the vicinity of the intermediate gradation, the transmission rate is greatly changed even for a small voltage change. Thus, it is easy to see flicker of the image. On the other hand, in the vicinity of the white and black, the transmission rate is not substantially changed for the small voltage change. Thus, it is hard to see the flicker. Also, the gradation voltage, on which the electric power consumption is large and the heat is generated in the data driving unit 2, is in the vicinity of the black where a high voltage is required for the charging/discharging.

Therefore, in the liquid crystal display device and the method for driving the same of the present invention, the 2H dot inversion driving method, in which the number of the polarity inversions is small, is selected in the gradation region in the vicinity of the black where the high voltage is required for the charging/discharging and it is hard to see the flicker. The dot inversion driving method is selected in the gradation region equal to or less than the intermediate gradation where it is easy to see the flicker. The gradation at which the dot inversion driving method and the 2H dot inversion driving method are switched is referred to as an inversion switching gradation, as shown in FIG. 2. This inversion switching gradation is the setting gradation in the image judging unit 11. The setting gradation is determined by the design for each liquid crystal display device.

Consequently, in the present invention, it is possible to reduce the electric power consumption while suppressing the deterioration in the image quality such as the flicker. The fact that the electric power consumption can be reduced is preferable because the heat generation of each unit such as the data driving unit 2 can be suppressed.

Incidentally, in the gradation region in the vicinity of the white where it is hard to see the flicker, the dot inversion driving method whose image quality is excellent may be used, or the 2H dot inversion driving method whose electric power consumption is small may be used. That is, a plurality of setting gradations can be set to use a plurality of driving methods. In that case, the control for suppressing the electric power consumption can be executed further appropriately and finely, while the deterioration in the image quality is avoided.

Here, the 2H dot inversion driving method and the dot inversion driving method are used. However, it is also possible to use different methods, for example, a 3H dot inversion driving method and the dot inversion driving method. When the dot inversion driving method of 3H or higher (for example: a 4H dot inversion driving method) is used, the electric power consumption can be further reduced. Thus, this is further preferable.

Incidentally, in the case of the normally black, the foregoing relation between the white and the black becomes opposite. That is, the black becomes at about 0 V to 2 V, and the white becomes at about 3 V to 5 V. Thus, it is the vicinity of the white where the high voltage is required for the charging/discharging.

An operation of the first embodiment of the liquid crystal display device according to the present invention (the method for driving the same) will be described below.

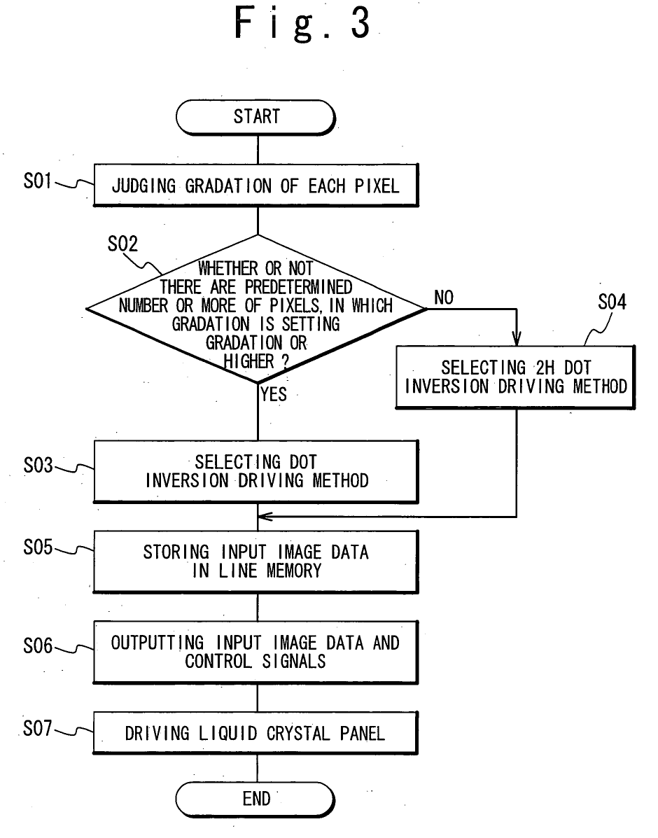

FIG. 3 is a flowchart showing the operation of the first embodiment of the liquid crystal display device according to the present invention. Here, the case is explained in which the liquid crystal panel is a normally white type panel, and the inversion driving method is selected for each 4 lines (4 gate lines) of horizontal pixels.

(1) Step S01:

The image drawing unit 7 transmits the input image data 28 to the image judging unit 11. The image judging unit 11 judges whether or not the gradation of each pixel of the input image data 28 is equal to or higher than the setting gradation.

(2) Step S02:

The method selecting unit 12 judges whether or not there are the predetermined number or more of the pixels, in which the image data has the gradation of the setting gradation or higher, in the input image data 28 corresponding to the 4 lines.

(3) Step S03:

If there are the predetermined number or more of the pixels, in which the image data has the gradation of the setting gradation or higher, in the input image data 28 corresponding to the 4 lines, the method selecting unit 12 selects the dot inversion driving method as the method for driving the input image data 28 corresponding to the 4 lines.

(4) Step S04:

If there are not the predetermined number or more of the pixels, in which the image data has the gradation of the setting gradation or higher, in the input image data 28 corresponding to the 4 lines, the method selecting unit 12 selects the 2H dot inversion driving method as the method for driving the input image data 28 corresponding to the 4 lines.

(5) Step S05:

The line memory 13 sequentially stores the input image data 28 judged by the image judging unit 11. The line memory 13 corresponds to the 4 lines corresponding to the number of the horizontal pixels in the liquid crystal panel 4, which is the unit of the selection of the driving method.

(6) Step S06:

The input image data 28 corresponding to the 4 lines stored in the line memory 13 are outputted as the image data 21 sequentially to the data driving unit 2, after the selection of the driving method. Simultaneously, the data-side control signal including the control signal indicating the driving method selected by the method selecting unit 12 is outputted from the LCD control unit 5 to the data driving unit 2. The gate-side control signal is outputted from the LCD control unit 5 to the gate driving unit 3.

(7) Step S07:

The liquid crystal panel 4 is driven by the output signal from the data driving unit 2 and the output signal from the gate driving unit 3.

The foregoing operation can operate the liquid crystal display device.

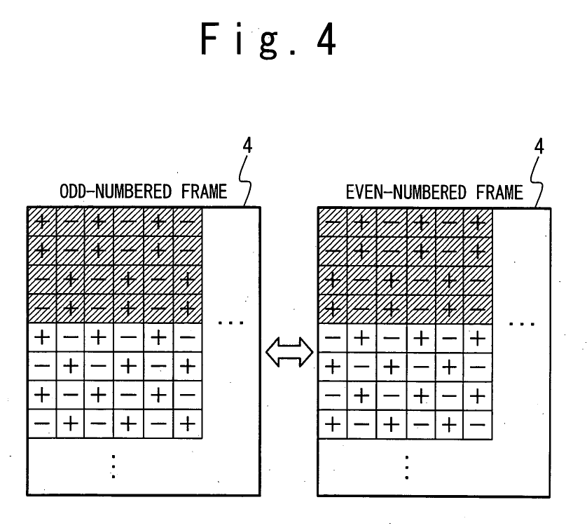

FIG. 4 is a conceptual view showing the voltage polarity applied to the liquid crystal panel 4 in the present invention. Each quadrangle in the liquid crystal panel 4 indicates the pixel. The symbols “+” and “−” in the quadrangle indicates the voltage polarity in the pixel. The liquid crystal panel 4 on the left side indicates an odd-numbered frame, and the liquid crystal panel 4 on the right side indicates an even-numbered frame, respectively.

In the region (in FIG. 4, the hatching portion) where in the input image data 28 corresponding to the 4 lines, there are not the predetermined number or more of the pixels, in each of which the image data has the gradation of the setting gradation or higher, the polarity inversion is carried out by the 2H dot inversion driving method. On the other hand, in the region (in FIG. 4, the no-hatching portion) where there are the predetermined number or more of the pixels, the polarity inversion is carried out by the dot inversion driving method. That is, the driving method where the dot inversion driving method and the 2H dot inversion driving method are switched every 4 vertical lines is used.

However, it is preferable that the image judging unit 11 and the method selecting unit 12 determine (select) and switch the polarity inverting method every two frames. That is, one even-numbered frame and one odd-numbered frame shown in FIG. 4 are preferably defined as one set, and the polarity inverting method is determined (selected) and switched every one set. This is because there is a possibility that a direct-current voltage is continuously applied to the liquid crystal panel if the polarity inverting method is switched between the dot inversion and the 2H dot inversion every one frame. This direct-current voltage may bring about a burn-in in the liquid crystal panel.

Here, the case of determining the inversion driving method every 4 lines (4 gate lines) of the horizontal pixels is explained. However, the number of the lines (the number of the gate lines) of the horizontal pixels is not limited to this example. That is, here, the driving method is determined (selected) and changed between the dot inversion driving method of a 2-line cycle and the 2H dot inversion driving method of a 4-line cycle. Thus, it is preferable to determine (select) and change the driving method at a 4m-line cycle (m is a natural number) that is a common multiple between the 2-line cycle and the 4-line cycle. The determination (selection) and change of the driving method at the 4-line cycle of the minimum common multiple of m=1 as described in this embodiment is further preferable because the deterioration in the image quality is suppressed.

With the configurations and operations of the present invention as mentioned above, it is possible to reduce the electric power consumption while suppressing the deterioration in the image quality such as the generation of flicker, and to suppress the heat generation at each portion such as the data driving unit 2.

Here, with regard to all of the pixels, the driving method for the polarity inversion is determined based on the gradation. However, the present invention is not limited to the example. For example, the driving method of the present invention may be applied to the pixels of the G-signal in the RGB signal, and the 2H dot inversion driving method may be applied to the remaining R-signal and B-signal. The G-signal includes much brightness data rather than the remaining R-signal and B-signal. Thus, when the present invention is applied to the G-signal, it becomes hard to see the flicker. In this case, as compare with the case of applying the present invention to all of the pixels, it becomes easy to control the driving method. Also, the use of the 2H dot inversion driving method for the remaining R-signal and B-signal enables the further reduction in the electric power consumption and heat generation.

In the gate driving unit 2 in the liquid crystal display device of the present invention, for example, it is possible to use a driving circuit of a matrix type liquid crystal display device disclosed in Japanese Patent 3056085B.

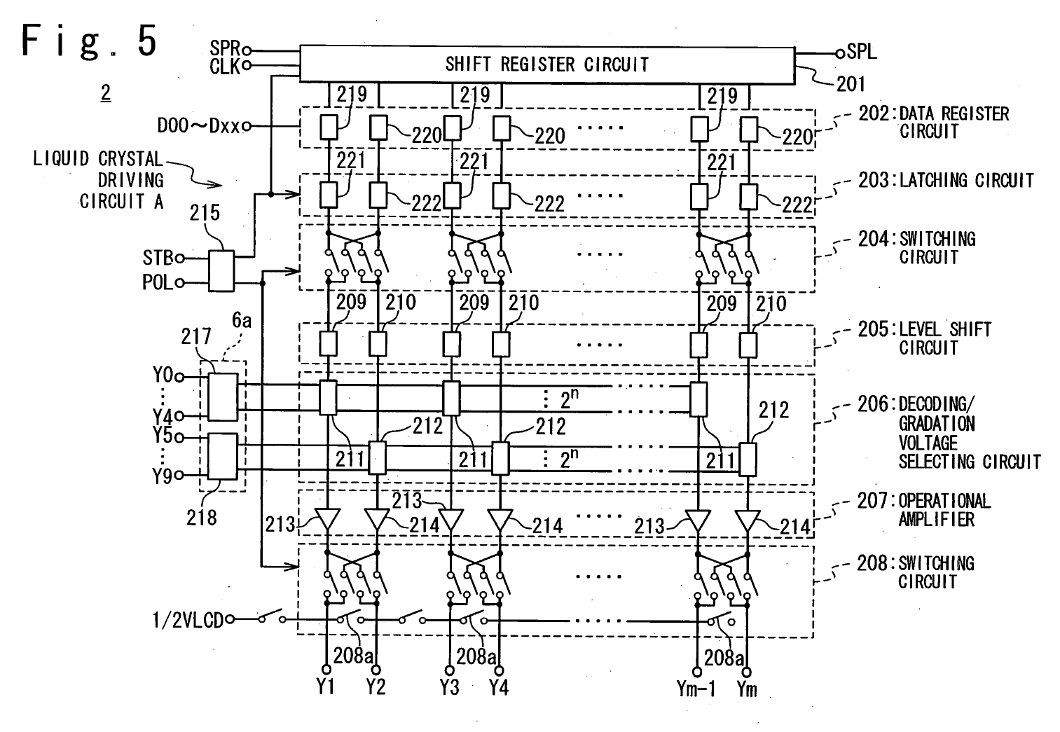

FIG. 5 is a block diagram showing the gate driving unit 2 in the liquid crystal display device of the present invention. The gate driving unit 2 includes a liquid crystal driving circuit A and switching circuits 204, 208.

The liquid crystal driving circuit A outputs plus and minus voltages, with a half voltage of the supplied liquid crystal driving voltage or a voltage Vcom of a liquid crystal common electrode as a reference, based on the applied image data. The liquid crystal driving circuit A includes a shift register circuit 201, a data register circuit 202, a latching circuit 203, a level shift circuit 205, a decoding/gradation voltage selecting circuit 206 and an operational amplifier 207. Those circuit configurations are composed of two systems. Incidentally, in the present invention, the voltage Vcom of the liquid crystal common electrode is used as the reference. Then, when the liquid crystal driving voltage is equal to or higher than this voltage Vcom, the plus voltage is applied as the liquid crystal driving voltage. When the liquid crystal driving voltage is lower than the voltage Vcom, the minus voltage is applied as the liquid crystal driving voltage. Then, the alternate drive is carried out by applying them while keeping the amplitude relation.

The data register circuit 202 latches in parallel the image data 21 (D00 to Dxx) of n (n is a natural number) bits to be controlled, in response to the outputs of the respective columns of the shift register circuit 201. This has the two systems. One system includes data register circuits 219 and another system includes data register circuits 220. One data register circuit 219 and one data register circuit 220 are defined as one set. The data register circuit 202 includes m sets of the data register circuits 219 and 220.

The latching circuit 203 collectively latches the n-bit data (the image data 21: D00 to Dxx) from the data register circuit 202, in response to a latch signal (hereafter, “STB signal”). This has the two systems. One system includes latching circuits 221, each of which is connected to the data register circuit 219. Another system includes latching circuits 222, each of which is connected to the data register circuit 220. One latching circuit 221 and one latching circuit 222 are defined as one set. The latching circuit 203 includes m sets of the latching circuits 221 and 222.

The level shift circuit 205 boosts the n-bit data from the latching circuit 203 up to the liquid crystal driving voltages of different voltage values. This has the two systems. One system includes level shift circuits 209 on a high-voltage-side. Another system includes level shift circuits 210 on a low-voltage-side. One level shift circuit 209 and one level shift circuit 210 are defined as one set. The level shift circuit 205 includes m sets of the level shift circuits 209 and 210. In this embodiment, the level shift circuit 209 on the high-voltage-side is designed, for example, so as to boost 3.3 V up to 10 V, and the level shift circuit 210 on the low-voltage-side is designed, for example, so as to boost 3.3 V up to 5V. However, it is not limited to this boost-up rate. The conventionally known circuit can be used as the level shift circuit 205.

A switching circuit 204 selectively connects the output of the latching circuit 221 of one system to any one of the high-voltage-side level shift circuit 209 and the low-voltage-side level shift circuit 210, based on the control signal from a timing control circuit 215. Simultaneously, the switching circuit 204 selectively connects the output of the latching circuit 222 of the other one system to the other one of the high-voltage-side level shift circuit 209 and the low-voltage-side level shift circuit 210.

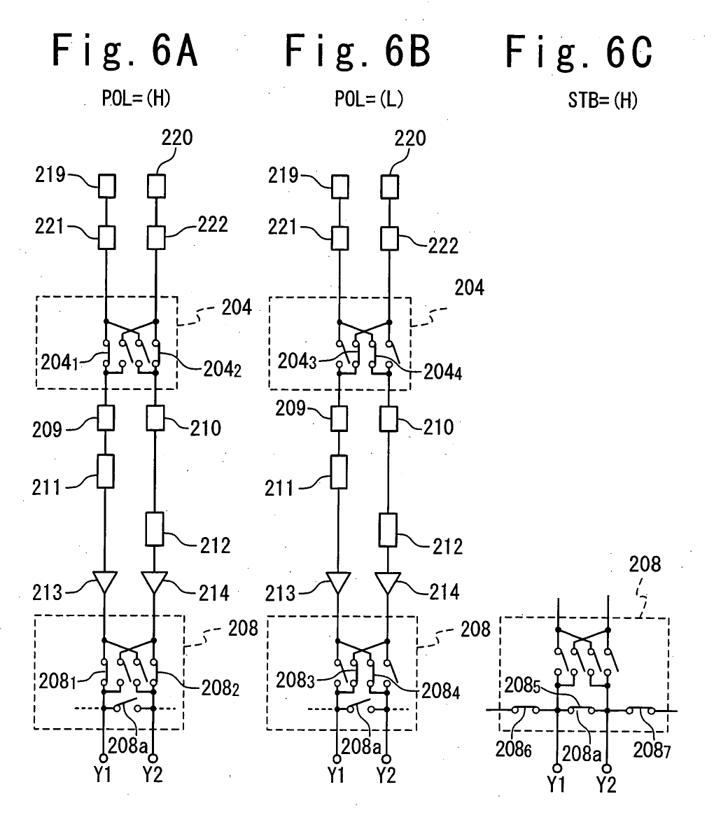

FIGS. 6A to 6C are block diagrams showing the examples of the switch controls in the respective circuits. The switching circuit 204 carries out the switch controls as follows. As shown in FIG. 6A, when a polarity signal (hereafter, “POL signal”) is at a high level (H) (STB signal=L), the latching circuit 221 is connected to the level shift circuit 209 of the high-voltage-side through a contact 204₁, and the latching circuit 222 is connected to the level shift circuit 210 of the low-voltage-side through a contact 204₂. On the other hand, as shown in FIG. 6B, when the POL signal is at a low level (L) (STB signal=L), oppositely to FIG. 6A, the latching circuit 221 is connected to the level shift circuit 210 of the low-voltage-side through a contact 204₄, and the latching circuit 222 is connected to the level shift circuit 209 of the high-voltage-side through a contact 204₃. However, the POL signal and the STB signal are included in the data-side control signal to be outputted from the level shift circuit 205 to the timing control circuit 215.

A gradation voltage generating circuit 6a includes the circuits of the two systems. One system includes a high-voltage-side gradation voltage generating circuit 217 and another system includes a low-voltage-side gradation voltage generating circuit 218. The respective gradation voltage generating circuits 217 and 218 slightly adjust the gradation voltages, which are displayed as the gradations on the liquid crystal panel, to 2n values, based on external inputs V0, V1, V2, V3 and V4 and external inputs V5, V6, V7, V8 and V9 (reference voltages 24), respectively. Also, the respective gradation voltage generating circuits 217 and 218 slightly adjust the gradation voltages to resistance ratios corresponding to a γ curve of the liquid crystal by using a resistance division method, based on the external inputs V0, V1, V2, V3 and V4 and the external inputs V5, V6, V7, V8 and V9, respectively. The gradation voltage generating circuit 6a may be included in the reference voltage generating unit 6.

The decoding/gradation voltage selecting circuit 206 includes a high-voltage-side decoding/gradation voltage selecting circuit 211 and a low-voltage-side decoding/gradation voltage selecting circuit 212. The respective decoding/gradation voltage selecting circuits 211 and 212 receives the 2n values of the gradation voltages outputted by the respective gradation voltage generating circuits 217 and 218 as reference voltages S. As for them, a decoding unit decodes the voltages corresponding to the gradation signals of the 2n values (for example: 64 gradation signals (n=6 bits)), and selects one value among them, based on the outputs from the respective level shift circuits 209 and 210. Then, it is amplified by an operational amplifier OP and outputted to the operational amplifier 207 at the later stage.

The operational amplifier 207 has the two systems. One system includes a high-voltage-side operational amplifier 213 and another system includes a low-voltage-side operational amplifier 214. One high-voltage-side operational amplifier 213 and one low-voltage-side operational amplifier 214 are defined as one set. The operational amplifier 207 includes m sets of the high-voltage-side operational amplifier 213 and the low-voltage-side operational amplifier 214. The high-voltage-side operational amplifier 213 is assigned to amplify and output the high voltage outputted from the high-voltage-side decoding/gradation voltage selecting circuit 211. The low-voltage-side operational amplifier 214 is assigned to amplify and output the low voltage outputted from the low-voltage-side decoding/gradation voltage selecting circuit 212. The high-voltage-side operational amplifier 213 receives an input voltage of, for example, 5 V to 10 V and amplifies it to a range of 5 V to 10 V. Also, the low-voltage-side operational amplifier 214 receives an input voltage of, for example, 0 V to 5 V and amplifies it to a range of 0 V to 5 V.

The switching circuit 208 is shared at the two terminals of the two systems of the liquid crystal driving circuit A and outputs the plus and minus voltages to the respective terminals in time sequence and also controls the switch so as to output the voltages such that the plus and minus amplitude relation is mutually held between the two terminals. The switching circuit 208 has a common terminal switch 208a. The common terminal switch 208a commonly connects all output terminals Y1 to Ym of the liquid crystal driving circuit A and sets all of the output terminals Y1 to Ym to the half voltage of the liquid crystal driving voltage (½VLCD (for example: 5 V)). The withstand voltage of the switching circuit 208 directly connected to the liquid crystal is set to be two times or more of the threshold voltage value of the liquid crystal.

With reference to FIGS. 6A to 6C, the switching circuit 208 concretely controls the switch as follows. As shown in FIG. 6A, when the POL signal is at the high level (H) (STB signal=L), the high-voltage-side operational amplifier 213 is connected through a contact 208₁ to the output terminal Y1, and the low-voltage-side operational amplifier 214 is connected through a contact 208₂ to the output terminal Y2, respectively. On the other hand, as shown in FIG. 6B, when the POL signal is at the low level (L) (STB signal=L), oppositely to FIG. 6A, the high-voltage-side operational amplifier 213 is connected through a contact 208₄ to the output terminal Y2, and the low-voltage-side operational amplifier 214 is connected through a contact 208₃ to the output terminal Y1, respectively. Moreover, as shown in FIG. 6C, when the STB signal is at the high level (H), in spite of the state of the POL signal, the common terminal switch 208a (contacts 208₅, 208₆ and 208₇) is turned on, and all of the output terminals Y1 to Ym of the liquid crystal driving circuit A are commonly connected and set to ½VLCD.

Power source voltages of the respective circuits will be described below. In FIG. 5, the voltages of the data register circuits 219 and 220, latching circuits 221 and 222 and switching circuit 204 are limited to the range between 0 V and 3.3 V. The high-voltage-side level shift circuit 209 boosts the input voltages 0 V to 3.3 V to the output voltages 0 V to 5 V. Also, the voltages of the high-voltage-side decoding/gradation voltage selecting circuit 211 and operational amplifier 213 are limited to the range between 5 V and 10 V. The voltages of the low-voltage-side decoding/gradation voltage selecting circuit 212 and operational amplifier 214 are limited to the range between 0 V and 5 V. The voltage of the switching circuit 208 is limited to the range between 0 V and 10 V (the voltage Vcom=5 V of the liquid crystal common electrode). Also, as for the voltages applied as the external inputs to the high-voltage-side and low-voltage-side gradation voltage generating circuits 217 and 218, V0=10 V, V4=5.5 V, V5=4.5 V and V9=0 V, and V1, V2, V3, V6, V7 and V8 are at open states.

With regard to the operations (the step S07 in FIG. 3) of the first embodiment in the liquid crystal display device of the present invention that uses the gate driving unit 2 of FIG. 5, the case that the image data has 6 bits (64 gradations) will be exemplified below, with reference to FIGS. 1, 5, 6 and 7.

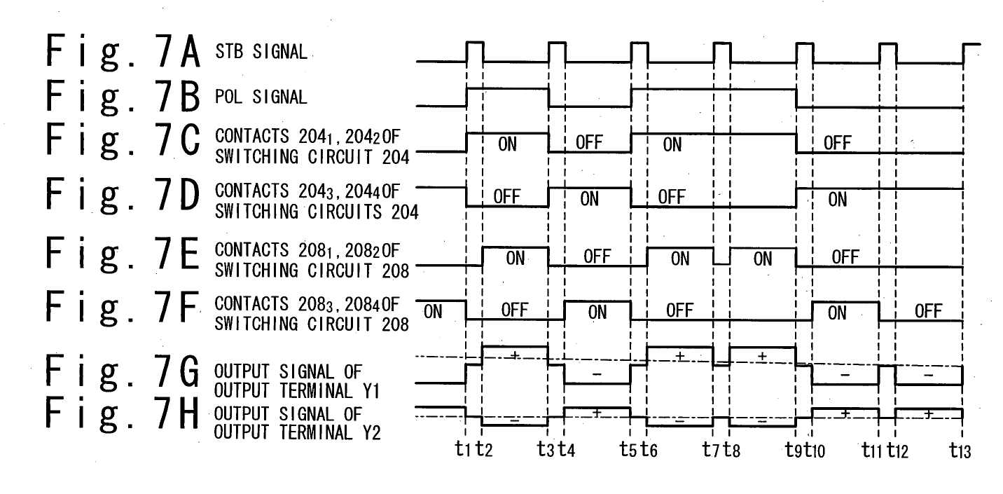

FIGS. 7A to 7H are timing charts showing the operation of the respective circuits shown in FIG. 5. FIG. 7A shows the STB signal. FIG. 7B shows the POL signal. FIG. 7C indicates the on/off states of the contacts 204₁ and 204₂ of the switching circuit 204. FIG. 7D shows the on/off states of the contacts 204₃ and 204₄ of the switching circuits 204. FIG. 7E shows the on/off states of the contacts 208₁ and 208₂ of the switching circuit 208. FIG. 7F shows the on/off states of the contacts 208₃ and 208₄ of the switching circuit 208. FIG. 7G shows the output signal of the output terminal Y1. FIG. 7H shows the output signal of the output terminal Y2.

Based on the POL signal and STB signal which are supplied to the timing control circuit 215, the switching circuit 204 and the switching circuit 208 are alternately switched as shown in FIGS. 6A and 6B. Thus, on the basis of which one of systems the image data of the 64 gradations passes through in the liquid crystal driving circuit A, the plus and minus voltages are alternately applied to the liquid crystal electrode.

Also, as shown in FIG. 6C and FIGS. 7A to 7H, in a period when the STB signal supplied to the timing control circuit 215 is at a high level (H), the contacts 208₁, 208₂, 208₃ and 208₄ are turned off and the contacts 208₅, 208₆ and 208₇ are turned on by the switching circuit 208. Then, all of the output terminals Y1 to Ym of the liquid crystal driving circuit A are reset to the half voltage of the liquid crystal driving voltage (for example, 5 V).

Also, when the cycle of the POL signal is set to a one-line cycle, the line of the liquid crystal panel 4 is driven by the dot inversion driving method. When the cycle of the POL signal is set to a two-line cycle, the lines of the liquid crystal panel 4 are driven by the 2H dot inversion driving method.

The operations will be described below in further detail. Let us suppose that the data register circuit 219 connected to the output terminal Y1 of the liquid crystal driving circuit A holds the data of a usually low level (L) (the image data whose gradation is constant), and the data register circuit 220 connected to the output terminal Y2 of the liquid crystal driving circuit A holds the data of a usually high level (H) (the image data whose gradation is constant).

(A) The Dot Inversion Driving Method

At a step S02 of FIG. 3, if it is judged that in the input image data 28 corresponding to the 4 lines, there are the predetermined number or more of the pixels, in which the image data has the gradation of the setting gradation or higher and if the dot inversion driving method is selected as the driving method, the operations are carried out, as indicated at times t=t1 to t5.

(1) t=t1 to t3

When the POL signal supplied to the timing control circuit 215 (FIG. 7B) is at the high level (H) (t=t1), based on the high level (H) of the STB signal (FIG. 7A), the contacts 208₁, 208₂ (FIG. 7E) and 208₃, 208₄ (FIG. 7F) of the switching circuit 208 are turned off, and the contacts 208₅, 208₆ and 208₇ (not shown in FIGS. 7A to 7H, and refer to FIG. 6C) are turned on.

At this time, in one of the two systems, the contact 204₁ (FIG. 7C) of the switching circuits 204 is turned on, and the contact 204₄ (FIG. 7D) is turned off. Thus, the data of the low level (L) held by the data register circuit 219 is transferred from the latching circuit 221 through the switching circuits 204 to the level shift circuit 209. The gradation voltage 10 V is selected by the decoding/gradation voltage selecting circuit 211 and current-amplified by the operational amplifier 213. Then, when the STB signal (FIG. 7A) is switched to the low level (t=t2), the contact 208₁ (FIG. 7E) of the switching circuit 208 is turned on, and the contacts 208₅, 208₆ are turned off. Thus, the image data is outputted through the switching circuit 208 to the output terminal Y1 (FIG. 7G) of the liquid crystal driving circuit A. Then, the gradation voltage 10 V (the polarity is plus (+)) of the predetermined voltage value is applied to the liquid crystal panel 4.

On the other hand, in the other of the two systems, the contact 204₂ (FIG. 7C) of the switching circuits 204 is turned on, and the contact 204₃ (FIG. 7D) is turned off. Thus, the data of the high level (H) held by the data register circuit 220 is transferred from the latching circuit 222 through the switching circuit 204 to the level shift circuit 210. The gradation voltage 4.5 V is selected by the decoding/gradation voltage selecting circuit 212 and current-amplified by the operational amplifier 214. Then, when the STB signal (FIG. 7A) is switched to the low level (t=t2), the contact 208₂ (FIG. 7E) of the switching circuit 208 is turned on, and the contacts 208₅, 208₆ are turned off. Thus, the image data is outputted through the switching circuit 208 to the output terminal Y2 (FIG. 7H) of the liquid crystal driving circuit A. Then, the gradation voltage 4.5 V (the polarity is minus (−)) of the predetermined voltage value is applied to the liquid crystal panel 4.

(2) t=t3 to t5

When the POL signal supplied to the timing control circuit 215 (FIG. 7B) is at the low level (L) (t=t3), based on the STB signal (FIG. 7A), the contacts 208₁, 208₂ (FIG. 7E) and 208₃, 208₄ (FIG. 7F) of the switching circuit 208 are turned off, and the contacts 208₅, 208₆ and 208₇ (not shown in FIGS. 7A to 7H) are turned on.

At this time, in one of the two systems, the contact 204₁ (FIG. 7C) of the switching circuits 204 is turned off, and the contact 204₄ (FIG. 7D) is turned on. Thus, the data of the low level (L) held by the data register circuit 219 is transferred from the latching circuit 221 through the switching circuits 204 to the level shift circuit 210. The gradation voltage 10 V is selected by the decoding/gradation voltage selecting circuit 212 and current-amplified by the operational amplifier 214. Then, when the STB signal (FIG. 7A) is switched to the low level (t=t4), the contact 208₃ (FIG. 7F) of the switching circuit 208 is turned on, and the contacts 208₅, 208₆ are turned off. Thus, the image data is outputted through the switching circuit 208 to the output terminal Y1 (FIG. 7G) of the liquid crystal driving circuit A. Then, the gradation voltage 10 V (the polarity is minus (−)) of the predetermined voltage value is applied to the liquid crystal panel 4.

On the other hand, in the other of the two systems, the contact 204₂ (FIG. 7C) of the switching circuits 204 is turned off, and the contact 204₃ (FIG. 7D) is turned on. Thus, the data of the high level (H) held by the data register circuit 220 is transferred from the latching circuit 222 through the switching circuits 204 to the level shift circuit 209. The gradation voltage 4.5 V is selected by the decoding/gradation voltage selecting circuit 211 and current-amplified by the operational amplifier 213. Then, when the STB signal (FIG. 7A) is switched to the low level (t=t4), the contact 208₄ (FIG. 7F) of the switching circuit 208 is turned on, and the contacts 208₅, 208₆ are turned off. Thus, the image data is outputted through the switching circuit 208 to the output terminal Y2 (FIG. 7H) of the liquid crystal driving circuit A. Then, the gradation voltage 4.5 V (the polarity is plus (+)) of the predetermined voltage value is applied to the liquid crystal panel 4.

(B) The 2H Dot Inversion Driving Method

At the step S02 of FIG. 3, if it is judged that in the input image data 28 corresponding to the 4 lines, there are not the predetermined number or more of the images, in which the image data has the gradation of the setting gradation or higher, and if the 2H dot inversion driving method is selected as the driving method, the operations become those indicated at t=t5 to t13. It is controlled in the inversion cycle of the POL signal included in the data-side control signal 22.

At t=t5 to t9, in the two cycles of the STB signal, the POL signal becomes constant at the plus (+). On the other hand, at t=t9 to t13, the POL signal becomes constant at the minus (−). That is, every two cycles of the STB signal, the driving method becomes the 2H dot inversion driving in which the polarity is inverted. The operations of the respective circuits are similar to the case of the dot inversion, except that the timings are different. Thus, their explanations are omitted.

As for the image data, the data is exchanged for each bit. In this way, since the circuits of the two systems of the liquid crystal driving circuit A are switched and controlled, the liquid crystal panel 4 is alternately driven.

The use of the data driving unit 2 as shown in FIG. 5 may allow the voltage width handled in one system to be small, as compared with the case that the circuit of the one system copes with the voltage that is equal to or higher than two times the threshold voltage of the liquid crystal, because the circuits of the two systems on the low-voltage-side and high-voltage-side are possessed. That is, it is possible to reduce the electric power consumption while suppressing the deterioration in the image quality and also possible to make the withstand voltage of each circuit lower.

### Second Embodiment

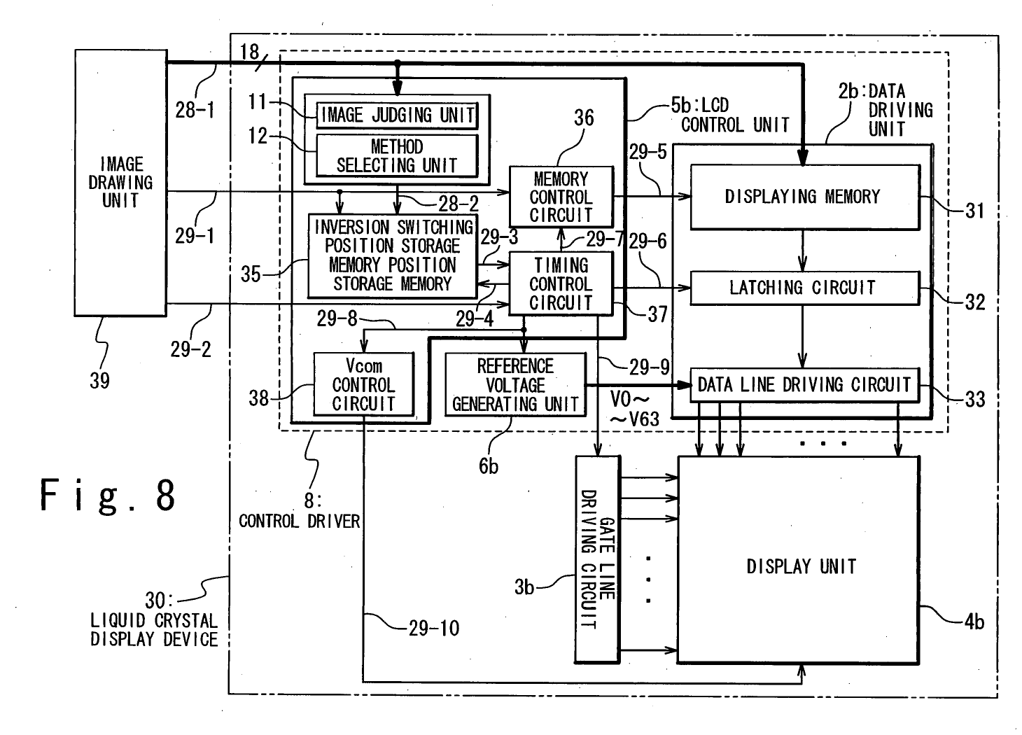

The configuration of the second embodiment of the liquid crystal display device according to the present invention will be described. FIG. 8 is a block diagram showing the configuration of the second embodiment of the liquid crystal display device of the present invention. A liquid crystal display device 30 includes a control driver 8, a gate line driving circuit 3b and a display unit 4b. This liquid crystal display device 30 is mainly used in a cellular phone.

The control driver 8 receives an input image data 28-1, a memory control signal 29-1, and a timing control signal 29-2 from an image drawing unit 39 (for example, CPU). Then, based on the input image data 28-1, the memory control signal 29-1, and the timing control signal 29-2, the control driver 8 controls a data line driving circuit 33 (which will be described later) possessed therein, the gate line driving circuit 3b and a common electrode of display unit 4b. Thus, the image corresponding to the input image data 28-1 is displayed on the display unit 4b. The control driver 8 has a data driving unit 2b, an LCD control unit 5b and a reference voltage generating unit 6b.

Here, the input image data 28-1 indicates the input image and includes the gradation data (RGB signal) of each pixel. The memory control signal 29-1 includes a V (vertical) address signal (indicating an address of a gate line). The memory control signal 29-1 is used to control a displaying memory 31 (which will be described later) of the data driving unit 2b. The timing control signal 29-2 is used to control the timings of the outputs of the data line driving circuit 33 and gate line driving circuit 3b. The timing control signal 29-2 includes a vertical synchronization signal, a horizontal synchronization signal, a clock signal and a data enable signal. A common voltage 29-10 of the common electrode is supplied from the control driver 8 directly to the display unit 4b.

The LCD control unit 5b receives the input image data 28-1, the memory control signal 29-1 and the timing control signal 29-2 from the image drawing unit 39. Then, based on the input image data 28-1, the memory control signal 29-1 and the timing control signal 29-2, the LCD control unit 5b outputs a displaying memory control signal 29-5, an STB signal 29-6 to the data driving unit 2b, outputs the gate-side control signal 29-9 to the gate line driving circuit 3b, and outputs Vcom (common voltage) 29-10 to the display unit 4b. The LCD control unit 5b includes the image judging unit 11, the method selecting unit 12, an inversion switching position storage memory 35, a memory control circuit 36, a timing control circuit 37 and a Vcom control circuit 38.

The image judging unit 11 receives the input image data 28-1. Its function is similar to that of the first embodiment. However, the comparison result (judgment result) is outputted to the method selecting unit 12. The method selecting unit 12 is similar to the first embodiment. However, a POL_SEL signal 28-2 indicating the selected inversion driving method (for example, “1” denotes a 2H gate line inversion driving method, and “0” denotes a gate line inversion driving method) is outputted to the inversion switching position storage memory 35.

The inversion switching position storage memory 35 stores the POL_SEL signal 28-2 (inversion driving method) in the memory used for the gate line corresponding to the V-address signal, based on the POL_SEL signal 28-2 and the V-address signal of the memory control signal 29-1. Then, based on a read signal 29-4 of the POL_SEL signal 28-2 from the timing control circuit 37, the POL_SEL signal 28-2 stored in the memory is outputted as a polarity inversion control signal 28-3.

The timing control circuit 37 inquires of the inversion switching position storage memory 35 about the inversion driving method of each gate line by using the read signal 29-4, based on the timing control signal 29-2. Then, the following signals are outputted based on the timing control signal 29-2 and polarity inversion control signal 28-3 as the inquired result. That is, a timing control signal 29-7 indicating an output timing of data in the displaying memory 31 of the data driving unit 2b is outputted to the memory control circuit 36. The STB signal 29-6 indicating an output timing of data in the latching circuit 32 (which will be described later) of the data driving unit 2b is outputted to the latching circuit 32. A polarity inversion control signal 29-8 indicating a timing of a polarity inversion (for example: 2H-gate line inversion or gate line inversion) to the reference voltage generating unit 6b and the Vcom control circuit 38. The gate line control signal 29-9 indicating an output timing of the gate line driving circuit 3b is outputted to the gate line driving circuit 3b.

The memory control circuit 36 outputs the timing control signal 29-5 indicating the output timing of the data in the displaying memory 31 of the data driving unit 2b to the displaying memory 31, based on the memory control signal 29-1 and the timing control signal 29-7.

The Vcom control circuit 38 outputs the Vcom (common voltage) 29-10 of the common electrode of the display unit 4b to the common electrode, based on the polarity inversion control signal 29-8. In order to attain the smaller electric power consumption, the Vcom (common voltage) 29-10 is alternately driven between 0 V and 5 V, and the output voltage to the data line is inversion-driven in the range of about 5 V. In the present invention, even this inversion drive timing is controlled based on the gradation of the input image data.

The reference voltage generating unit 6b generates the gradation voltages V0 to V63 corresponding to the gradations of the input image data corresponding to its polarity, as the plus (plus for the reference voltage) or minus (minus for the reference voltage) voltage, based on the polarity inversion control signal 29-8. Then, the gradation voltages V0 to V63 are outputted to the data line driving circuit 33 of the data driving unit 2b. In the present invention, even this plus or minus inversion timing of the gradation voltages V0 to V63 is controlled based on the gradation of the input image data.

The data driving unit 2b controls the plurality of data lines of the display unit 4b, based on the input image data 28-1, the STB signal 29-6, the timing control signal 29-5 and the gradation voltages V0 to V63. The data driving unit 2b includes the displaying memory 31, the latching circuit 32 and the data line driving circuit 33.

The displaying memory 31 stores the input image data corresponding to one frame of the display unit 4b. Then, this outputs the input image data to the latching circuit 32, one line by one line, based on the timing control signal 29-5.

The latching circuit 32 stores the input image data outputted by the displaying memory 31, one line at a time. Then, based on the STB signal 29-6, the input image data 21 is outputted to the data line driving circuit 33, one line at a time.

The data line driving circuit 33 amplifies the input image data corresponding to the one line outputted by the latching circuit 32, to the gradation voltage for each pixel. Then, it is outputted to the data line of the display unit 4b.

The control driver 8 transfers the image data from the image drawing unit 39 to the data driving unit 2b, only when the image is changed. In a case of a still image, the image data stored in the displaying memory 31 are read for each line and outputted to the display unit 4b.

If the input image data is not newly supplied from the image drawing unit 39 (still image), the image data accumulated in the displaying memory 31 is not changed. In addition, the POL_SEL signal accumulated in the inversion switching position storage memory 35 (memory 35b) is not changed. Thus, in the case of the still image, the inversion driving method at each pixel is not changed, and the image is displayed on the display unit 4b.

The gate line driving circuit 3b controls the plurality of gate lines of the display unit 4b, based on the gate-side control signal 29-9.

The display unit 4b is the liquid crystal panel for displaying the image, in which the plurality of gate lines and the plurality of data lines are controlled by the data line driving circuit 33 and the gate line driving circuit 3b, respectively.

Here, the setting gradation and judgment of the image data in the image judging unit 11 shown in FIG. 8 is similar to those of the first embodiment (explanation in FIG. 2). Thus, their explanations are omitted.

Also in this embodiment, it is possible to reduce the electric power consumption while suppressing the deterioration in the image such as the generation of the flicker. The fact that the electric power consumption can be reduced is preferable because the heat generation can be suppressed in each unit such as the data line driving circuit 33.

Incidentally, in the gradation region near the white where it is hard to see the flicker, the gate line inversion method whose image quality is excellent may be used, or the 2H gate line inversion driving method whose electric power consumption is small may be used. That is, the plurality of setting gradations can be set to use the plurality of driving methods. In that case, the control for suppressing the electric power consumption while avoiding the deterioration in the image quality can be executed properly and precisely.

Also, here, the 2H gate line inversion driving method and the gate line inversion driving method are used. However, for example, the 3H gate line inversion driving method and the gate line inversion driving method can be used. In the case of using the 3H or greater gate line inversion driving method (for example, a 4H gate line inversion driving method), this is preferable because the electric power consumption can be further reduced.

Incidentally, in the case of the normally black, the foregoing relation between the white and the black becomes opposite. That is, the black becomes at about 0 V to 2 V, and the white becomes at about 3 V to 5 V. Thus, it is the vicinity of the white that requires the charging/discharging of the high voltage.

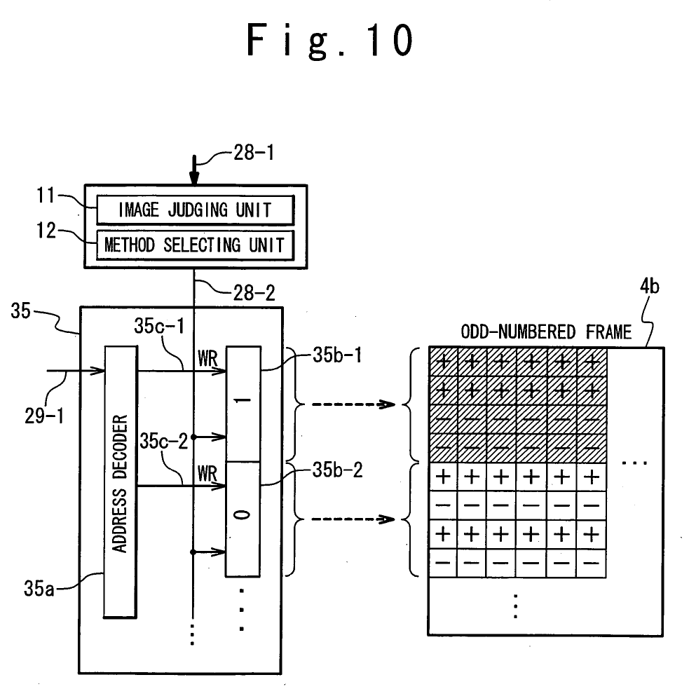

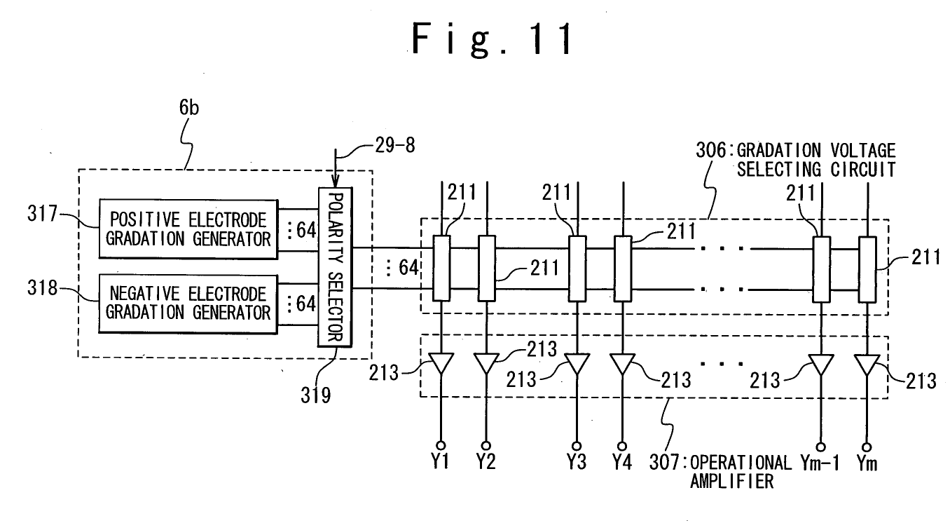

The inversion switching position storage memory 35 is explained in detail. FIG. 10 is a block diagram showing the configuration of the inversion switching position storage memory. The inversion switching position storage memory 35 includes an address decoder 35a and a memory 35b (-1 to q: q is a natural number).

The address decoder 35a decodes the V-address signal of the memory control signal 29-1. Then, the address decoder 35a outputs a write signal 35c (-1 to q) to the memory 35b used for the gate line corresponding to the V-address signal. For example, the address decoder 35a outputs a write signal 35c-1 to a memory 35b-1 used for 4 gate lines from the top of the gate line. The address decoder 35a outputs a write signal 35c-2 to a memory 35b-2 used for next 4 gate lines.

Each of the memories 35b (-1 to q) stores the POL_SEL signal 28-2 outputted at the same timing as the corresponding write signal 35c (-1 to q). For example, the memory 35b-1 stores the POL_SEL signal 28-2=1 outputted at the same timing as the write signal 35c-1. Thus, as shown in the right side of FIG. 10, the 4 gate lines from the top of the gate line becomes the 2H gate line inversion driving method. On the other hand, the memory 35b-2 stores the POL_SEL signal 28-2=0 outputted at the same timing as the write signal 35c-2. Thus, as shown in the right side of FIG. 10, the next 4 gate lines becomes the gate line inversion driving method.

The number (q) of the memories is ¼ of the total number of the gate lines (horizontal pixels). That is, the memory 35b is installed every 4 lines of the gate lines (horizontal scanning lines). This is because the inversion driving method is selected every 4 lines (4 gate lines) of the horizontal pixels.

However, the number of the lines (the number of the gate lines) of the horizontal pixels is not limited to this example. That is, here, the driving method is determined (selected) and changed between the gate line inversion driving method of the 2-line cycle and the 2H gate line inversion driving method of the 4-line cycle. Thus, the driving method is preferably determined (selected) and changed at a 4m-line cycle (m is a natural number) that is the common multiple between the 2-line cycle and the 4-line cycle. The determination (selection) and change of the driving method at the 4-line cycle of the minimum common multiple of m=1 such as this embodiment is further preferable because the deterioration in the image quality can be preferably suppressed.

The data line driving circuit 33 and the reference voltage generating unit 6b are explained in detail. FIG. 11 is a block diagram showing the configurations of the data line driving circuit 33 and reference voltage generating unit 6b.

The reference voltage generating unit 6b includes a positive electrode gradation generator 317, a negative electrode gradation generator 318 and a polarity selector 319. The positive electrode gradation generator 317 generates the reference gradation voltages (V0 to V63) when the polarity is positive. The negative electrode gradation generator 318 generates the reference gradation voltages (V0 to V63) when the polarity is negative. The polarity selector 319 outputs the reference gradation voltages corresponding to the polarity (plus or minus) indicated by the polarity inversion control signal 29-8 to the data line driving circuit 33.

The data line driving circuit 33 includes a gradation voltage selecting circuit 306 and an operational amplifier 307. The gradation voltage selecting circuit 306 has the gradation voltage selecting circuit 211, corresponding to each of the plurality of data lines. The gradation voltage selecting circuit 211 selects the gradation voltage corresponding to the image data, from the reference gradation voltages (V0 to V63) outputted by the reference voltage generating unit 6b. The operational amplifier 307 has an operational amplifier 213, correspondingly to each of the plurality of data lines. This amplifies the gradation voltage selected by the corresponding gradation voltage selecting circuit 211.

The operations of the second embodiment of the liquid crystal display device of the present invention (the method of driving the same) will be described below.

FIG. 3 is the flowchart showing the operations of the second embodiment of the liquid crystal display device of the present invention. Here, the case is explained where the liquid crystal panel is normally white, and the inversion driving method is selected every 4 lines (4 gate lines) of the horizontal pixels.

(1) Step S01:

As for the input image data 28-1 transmitted by the image drawing unit 39, the image judging unit 11 judges whether or not the gradation of each pixel of the input image data 28-1 is equal to or higher than the setting gradation.

(2) Step S02:

The method selecting unit 12 judges whether or not there are the predetermined number or more of the pixels, in which the image data has the gradation of the setting gradation or higher, in the input image data 28-1 corresponding to the 4 lines.

(3) Step S03:

If in the input image data 28-1 corresponding to the 4 lines, there are the predetermined number or more of the pixels, in which the image data has the gradation of the setting gradation or higher, the method selecting unit 12 selects the gate line inversion driving method as the method of driving the input image data 28-1 corresponding to the 4 lines.

(4) Step S04:

If in the input image data 28 corresponding to the 4 lines, there are not the predetermined number or more of the pixels, in which the image data has the gradation of the setting gradation or higher, the method selecting unit 12 selects the 2H gate line inversion driving method as the method of driving the input image data 28 corresponding to the 4 lines.

(5) Step S05:

At the same time, the input image data 28-1 is sequentially stored in the displaying memory 31.

(6) Step S06:

The input image data 28-1 stored in the displaying memory 31 is outputted to the latching circuit 32, based on the timing control signal 29-5. The input image data 28-1 stored in the latching circuit 32 is outputted to the data line driving circuit 33, based on the STB signal 29-6. As for the input image data 28-1 of the data line driving circuit 33, based on the reference voltage generating unit 6b, the output signal corresponding to one of the reference gradation voltages is outputted to the data line of the display unit 4b. At the same time, based on the gate line control signal 29-9, the gate line driving circuit 3b drives the gate lines of the display unit 4b. Moreover, based on the common voltage 29-10, the Vcom control circuit 38 drives the common electrode of the display unit 4b.

(7) Step S07:

Thus, the input image data are displayed on the display unit 4b. The display unit 4b (liquid crystal panel) is driven.

The foregoing operations can operate the liquid crystal display device.

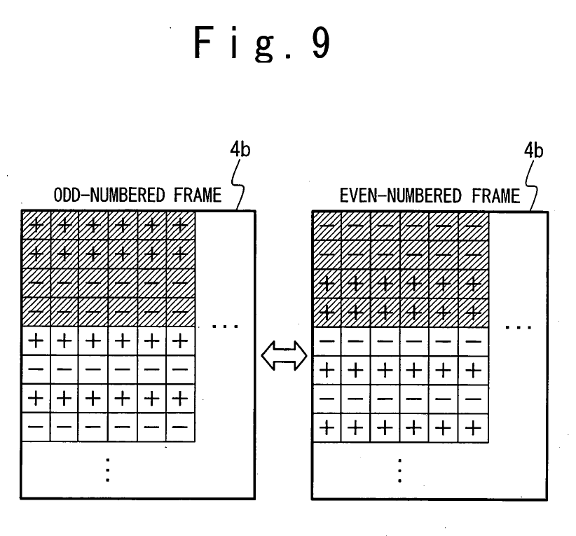

FIG. 9 is a conceptual view showing the voltage polarity applied to the liquid crystal panel 4 in the present invention. Each quadrangle in the liquid crystal panel 4 indicates the pixel. The symbols “+” and “−” in the quadrangle indicates the voltage polarity in the pixel. The liquid crystal panel 4 on the left side indicates the odd-numbered frame, and the liquid crystal panel 4 on the right side indicates the even-numbered frame, respectively.

In the region (in FIG. 9, the hatching portion) where in the input image data 28-1 corresponding to the 4 lines, there are not the predetermined number or more of the pixels, in which the image data has the gradation of the setting gradation or higher, the polarity inversion is carried out by the 2H gate line inversion driving method. On the other hand, in the region where there are the predetermined number or more of the pixels (in FIG. 9, the no-hatching portion), the polarity inversion is carried out by the gate line inversion driving method. That is, the driving method where the gate line inversion driving method and the 2H gate line inversion driving method are switched every 4 vertical lines is used.

However, the action where the image judging unit 11 and the method selecting unit 12 determine (select) and switch the polarity inverting method is preferably executed every two frames. That is, one even-numbered frame and one odd-numbered frame shown in FIG. 9 are defined as one set, and the polarity inverting method is determined (selected) and switched for each set. This is because there is a possibility that the direct-current voltage is always applied to the liquid crystal panel when the polarity inverting method is switched between the dot inversion and the 2H dot inversion for each frame. This direct-current voltage may bring about a burn-in in the liquid crystal panel.

Here, the case of determining the inversion driving method every 4 lines (4 gate lines) of the horizontal pixels is explained. However, the number of the lines (the number of the gate lines) of the horizontal pixels is not limited to this example. That is, here, the driving method is determined (selected) and changed between the gate line inversion driving method of the 2-line cycle and the 2H gate line inversion driving method of the 4-line cycle. Thus, it is preferable to determine (select) and change the driving method at the 4m-line cycle (m is the natural number) that is the common multiple between the 2-line cycle and the 4-line cycle. The determination (selection) and change of the driving method at the 4-line cycle of the minimum common multiple of m=1 as described in this embodiment is further preferable because the deterioration in the image quality is suppressed.

With the configurations and operations of the present invention as mentioned above, it is possible to reduce the electric power consumption while suppressing the deterioration in the image quality such as the generation of the flicker and to suppress the heat generation at each portion such as the data driving unit 2.

Here, with regard to all of the pixels, the driving method for inverting the polarity is determined based on the gradation. However, the present invention is not limited to the example. For example, the driving method of the present invention may be applied to the pixels of the G-signal in the RGB signal, and the 2H gate line inversion driving method may be applied to the remaining R-signal and B-signal. The G-signal includes much brightness data. Thus, when the present invention is applied to the G-signal, it becomes hard to see the flicker. In this case, as compare with the case of applying the present invention to all of the pixels, it becomes easy to control the driving method. Also, the use of the 2H gate line inversion driving method for the remaining R-signal and B-signal enables the further reduction in the electric power consumption and heat generation.

With regard to the operations (the step S07 in FIG. 3) of the second embodiment in the liquid crystal display device of the present invention, the case of the image data of 6 bits (64 gradations) will be exemplified below with reference to FIGS. 8, 10, 11 and 12A to 12D.

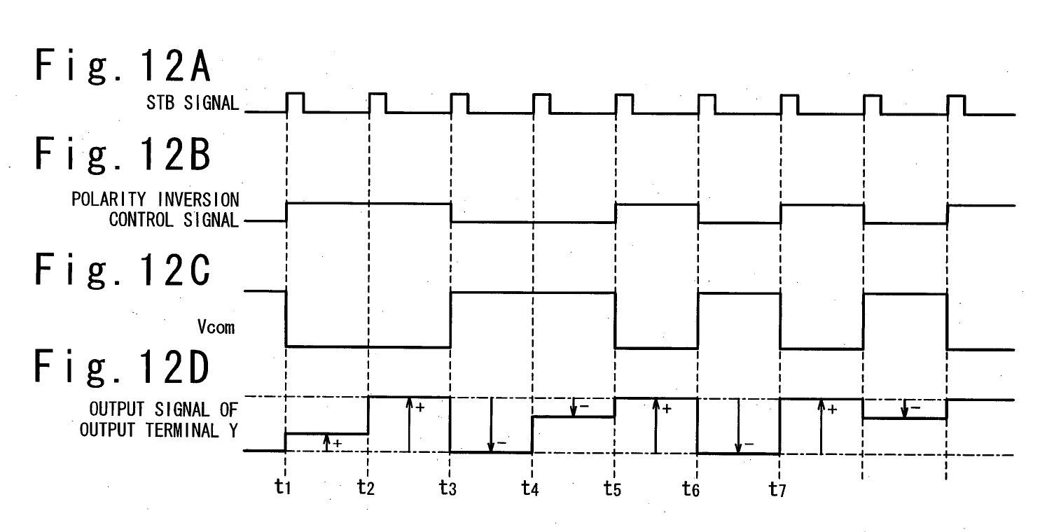

FIGS. 12A to 12D are the timing charts showing the operations of the respective circuits shown in FIG. 8. FIG. 12A shows the STB signal 29-6. FIG. 12B shows the polarity inversion control signal 29-8. FIG. 12C shows the Vcom 29-10. FIG. 12D shows the output signal of the output terminal Y.

Based on the STB signal and polarity inversion control signal 29-8 outputted from the timing control circuit 37, the polarities of the reference gradation voltages (corresponds to the output signals Y at the output terminals) V0 to V63 and the common voltage 29-1 are alternately switched at a predetermined cycle.

(A) The Gate Line Inversion Driving Method

At the step S02 of FIG. 3, if it is judged that in the input image data 28-1 corresponding to the 4 lines, there are the predetermined number or more of the pixels, in which the image data has the gradation of the setting gradation or higher, and if the gate line inversion driving method is selected as the driving method, the operations are carried out, as indicated at t=t5 to t7.

(1) t=t5 to t6

Each time the STB signal (FIG. 8A) becomes at the high level (H), the polarity of the polarity inversion control signal (FIG. 8B) is alternately switched. At t=t5 to t6, the polarity of the polarity inversion control signal (FIG. 8B) becomes plus, and the Vcom (FIG. 8C) becomes at the low level (L), and the output signal Y (FIG. 8D) of the output terminal indicates the plus gradation voltage.

(2) t=t6 to t7

At t=t5 to t6, the polarity of the polarity inversion control signal (FIG. 8B) becomes minus, and the Vcom (FIG. 8C) becomes at the high level (H), and the output signal Y (FIG. 8D) of the output terminal indicates the minus gradation voltage.

(B) The 2H Gate Line Inversion Driving Method

At the step S02 of FIG. 3, if it is judged that in the input image data 28-1 corresponding to the 4 lines, there are not the predetermined number or more of the pixels, in which the image data has the gradation of the setting gradation or higher, and if the 2H gate line inversion driving method is selected as the driving method, the operations are carried out, as indicated at t=t1 to t5.

(1) t=t1 to t3

Each time the STB signal (FIG. 7A) becomes at the high level (H), the input image data is changed. However, the polarity of the polarity inversion control signal (FIG. 8B) is alternately switched, very two times the STB signal (FIG. 8A) becomes at the high level (H). At t=t1 to t3, the polarity of the polarity inversion control signal (FIG. 8B) becomes plus, and the Vcom (FIG. 8C) becomes at the low level (L), and the output signal Y (FIG. 8D) of the output terminal indicates the plus gradation voltage.

(2) t=t3 to t5

At t=t3 to t5, the polarity of the polarity inversion control signal (FIG. 8B) becomes minus, and the Vcom (FIG. 8C) becomes at the high level (H), and the output signal Y (FIG. 8D) of the output terminal indicates the minus gradation voltage.

The control driver 8 alternately drives the Vcom as shown in FIG. 12C. Thus, as compared with the case where the Vcom is not alternately driven, it is possible to halve the output voltage (FIG. 12D) to the data line. For example, in the dot inversion drive in the first embodiment, Vcom=5 V, the data line voltage minus property is 0 V to 5 V, and the data line voltage plus property is 5 V to 10 V. On the other hand, in the gate line inversion drive in this embodiment, the data line voltage minus property is 5 V to 0 V (Vcom=5 V), and the data line voltage plus property is 0 V to 5 V (Vcom=0 V).

In addition to the control driver 8 (with the data driving unit 2b, the LCD control unit 5b and the reference voltage generating unit 6b), the gate line driving circuit 3b and the display unit 4b, which have been conventionally used, the LCD control unit 5b includes the image judging unit 11, the method selecting unit 12 and the inversion switching position storage memory 35 in the present invention. Adding those functions can change the inversion driving method of the polarity, based on the value of the gradation of the input image data. Thus, it is possible to reduce the electric power consumption while suppressing the deterioration in the image quality such as the generation of the flicker, and to suppress the heat generation of each unit such as the data driving unit 2.

### Third Embodiment

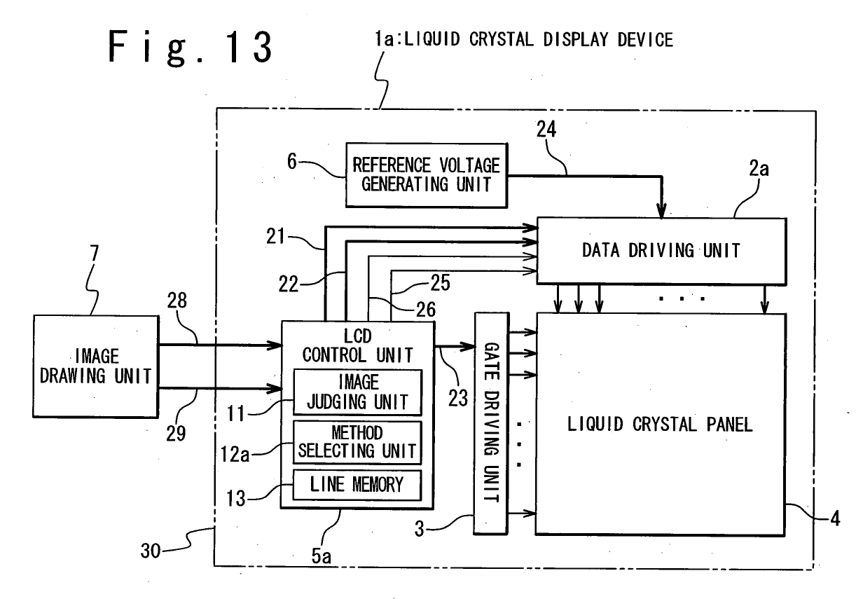

At first, the configuration of the third embodiment of the liquid crystal display device of the present invention will be described. FIG. 13 is a block diagram showing a configuration of the third embodiment of the liquid crystal display device according to the present invention. A liquid crystal display device 1a includes a data driving unit 2a, a gate driving unit 3, a liquid crystal panel 4, an LCD control unit 5a and a reference voltage generating unit 6.

The LCD control unit 5a receives the input image data 28 and the displaying control signal 29 from the image drawing unit 7 (for example: CPU). The input image data 28 and the displaying control signal 29 are similar to those of the first embodiment. Then, based on the input image data 28 and the displaying control signal 29, the LCD control unit 5a outputs the image data 21, the data-side control signal 22, a second polarity inversion signal 25 and the polarity inversion switching control signal 26 to the data driving unit 2, and outputs the gate-side control signal 23 to the gate driving unit 3. Hereinafter, the second polarity inversion signal 25 is referred to as the POL_{—}2 signal 25, and the polarity inversion switching control signal 26 is referred to as the POL_SEL signal 26. The data-side control signal 22 includes a polarity inversion signal (hereafter, referred to as a POL signal) in addition to the usual data-side control signal. The gate-side control signal 23 includes the usual gate-side control signal.

The polarity inversion signal (POL signal) is always outputted at the timing when a plurality of pixels (block) less than one frame are driven by the dot inversion driving method. The second polarity inversion signal (POL_{—}2 signal) is always outputted at the timing when the plurality of pixels (block) less than one frame are driven by the 2H dot inversion driving method. The polarity inversion switching control signal (POL_SEL signal) controls whether the plurality of pixels (block) less than one frame are driven by the dot inversion driving method or 2H dot inversion driving method (selection of the POL signal or POL_{—}2 signal).

The LCD control unit 5a includes the image judging unit 11, a method selecting unit 12a and the line memory 13.

The image judging unit 11 compares the setting gradation with the gradation of each pixel of the input image data 28, and judges whether the gradation of the input image data 28 is higher or lower than the setting gradation. The compared result (judged result) is outputted to the method selecting unit 12a. The input image data 28 is outputted to the line memory 13.

The method selecting unit 12a selects (determines) the inversion driving method when the input image data is displayed on the liquid crystal panel 4, for each of the plurality of pixels less than one frame, based on the compared result. “The plurality of pixels of the less than one frame” (hereinafter, also referred to as a “predetermined pixels”) is exemplified as “the block of the plurality of pixels” (hereinafter, also referred to as a “predetermined pixel block”). The predetermined pixel block is exemplified as the 8-pixel block configured to (the 4 pixels (vertical))×(the 2 pixels (horizontal)) Since the determining (selecting) method is similar to that of the first embodiment, its explanation is omitted.

The line memory 13 transiently stores the input image data 28 corresponding to the line of the pixels in the vertical direction, in the block of the pixels judged by the method selecting unit 12a. For example, the line memory 13 stores the image data 28 corresponding to the 4 lines, when the method selecting unit 12a carries out the judgment for each pixel block of (the 4 pixels (vertical))×(the two pixels (horizontal)). Then, after storing the input image data 28 corresponding to the plurality of lines, the line memory 13 outputs the input image data 28 as the image data 21 to the data driving unit 13. The line memory 13 is provided to perform the timing adjustment between the image data 21 and the data-side control signal 22 that the judged result is reflected when the image data 21 is outputted to the data driving unit 13.

The reference voltage generating unit 6 generates the reference gradation voltages 24 corresponding to the gradations of the input image data and outputs the gradation voltages to the data driving unit 2a.

The gate driving unit 3 controls the plurality of gate lines of the liquid crystal panel 4, based on the gate-side control signal 23. The gate driving unit 3 may be configured integrally with the LCD control unit 5. In that case, the circuit area can be reduced.

The data driving unit 2a controls the plurality of data lines of the liquid crystal panel 4, based on the input image data 21, the data-side control signal 22, the second polarity inversion signal (POL_{—}2 signal) 25, the polarity inversion switching control signal (POL_SEL signal) 26 and the reference gradation voltages 24. The data driving unit 2a may be configured integrally with the LCD control unit 5. In that case, the circuit area can be reduced.

The liquid crystal panel 4 displays an image based on the controls of the plurality of gate lines by the data driving unit 2 and the plurality of data lines by the gate driving unit 3.

Here, the setting gradation and judgment of the image in the image judging unit 11 shown in FIG. 13 is similar to the first embodiment (explanation in FIG. 2). Thus, their explanations are omitted.

Also in this embodiment, it is possible to reduce the electric power consumption while suppressing the deterioration in the image such as the generation of the flicker. It is preferable that the electric power consumption can be reduced because the heat generation can be suppressed in each unit such as the data driving unit 2a.

Incidentally, in the gradation region near the white where it is hard to see the flicker, the dot inversion method whose image quality is excellent may be used, or the 2H dot inversion driving method whose electric power consumption is small may be used. That is, the plurality of setting gradations can be set to use the plurality of driving methods. In that case, the control for suppressing the electric power consumption while avoiding the deterioration in the image quality can be executed properly and precisely.

Also, here, the 2H dot inversion driving method and the dot inversion driving method are used. However, for example, a 3H dot line inversion driving method and the dot inversion driving method can be used. It is preferable that using the 3H or greater dot inversion driving method (for example, a 4H dot inversion driving method) because the electric power consumption can be further reduced.

Incidentally, in the case of the normally black, the foregoing relation between the white and the black becomes opposite. That is, the black becomes at about 0 V to 2 V, and the white becomes at about 3 V to 5 V. Thus, it is the vicinity of the white that requires the charging/discharging of the high voltage.

The operations of the third embodiment of the liquid crystal display device (the method of driving the liquid crystal display device) of the present invention will be described below.

FIG. 3 is the flowchart showing the operations of the third embodiment of the liquid crystal display device of the present invention. Here, the case is explained where the liquid crystal panel is normally white, and the inversion driving method is selected for each pixel block of (the 4 pixels (vertical))×(the 2 pixels (horizontal).

(1) Step S01:

As for the input image data 28 transmitted by the image drawing unit 7, the image judging unit 11 judges whether or not the gradation of each pixel of the input image data 28 is equal to or higher than the setting gradation.

(2) Step S02:

The method selecting unit 12a judges whether or not there are the predetermined number or more of the pixels, in which the image data has the gradation of the setting gradation or higher, in the input image data 28 of the pixel block of (the 4 pixels (vertical))×(the 2 pixels (horizontal)).

(3) Step S03:

If in the input image data 28 of the pixel block, there are the predetermined number or more of the pixels, in which the image data has the gradation of the setting gradation or higher, the method selecting unit 12a selects the dot inversion driving method as the method of driving the input image data 28 of the pixel block.

(4) Step S04:

If in the input image data 28 of the pixel block, there are not the predetermined number or more of the pixels, in which the image data has the gradation of the setting gradation or higher, the method selecting unit 12a selects the 2H dot inversion driving method as the method of driving the input image data 28 of the pixel block.

(5) Step S05:

The input image data 28 judged by the image judging unit 11 is sequentially stored in the line memory 13. The line memory 13 has the elements corresponding to the 4 lines corresponding to the number of the horizontal pixels of the liquid crystal panel 4 that is the unit of the judgment of the driving method. The elements corresponding to the 4 lines correspond to the 4 pixels (vertical) of the pixel block.

(6) Step S06:

The input image data 28 corresponding to the 4 lines stored in the line memory 13 is sequentially outputted as the image data 21 to the data driving unit 2, after the selection of the driving method. Simultaneously, the data-side control signal 22 including the POL signal, the POL_{—}2 signal 25, and the POL_SEL signal 26 indicating the driving method selected by the method selecting unit 12a are outputted from the LCD control unit 5 to the data driving unit 2. The gate-side control signal is outputted from the LCD control unit 5 to the gate driving unit 3. The reference gradation voltages 24 are outputted from the reference voltage generating unit 6 to the data driving unit 2.

(7) Step S07:

Thus, the liquid crystal panel 4 is driven by the output signal from the data driving unit 2 and the output signal from the gate driving unit 3.

The foregoing operations can operate the liquid crystal display device.

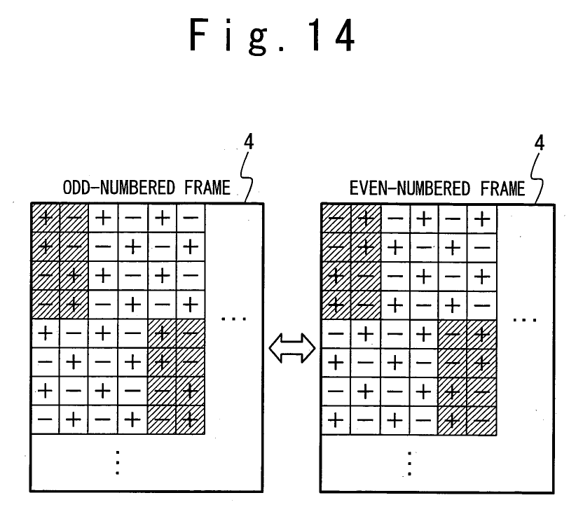

FIG. 14 is a conceptual view showing the voltage polarity applied to the liquid crystal panel 4 in the present invention. Each quadrangle in the liquid crystal panel 4 indicates the pixel. The symbol “+” and “−” in the quadrangle indicates the voltage polarity in the pixel. The liquid crystal panel 4 on the left side indicates the odd-numbered frame, and the liquid crystal panel 4 on the right side indicates the even-numbered frame, respectively.

In the region (in FIG. 14, the patterned portion) where in the input image data 28 of the pixel block of (the 4 pixels (vertical))×(the 2 pixels (horizontal)), there are not the predetermined number or more of the pixels, in which the image data has the gradation of the setting gradation or higher, the polarity inversion is carried out by the 2H dot inversion driving method. That is, the driving method where the dot inversion driving method and the 2H dot inversion driving method are switched at the pixel block unit of (the 4 pixels (vertical)×(the 2 pixels (horizontal)) is used.

However, it is preferable that the image judging unit 11 and the method selecting unit 12 determine (select) and switch the polarity inverting method every two frames. That is, it is preferable that one odd-numbered frame and one even-numbered frame shown in FIG. 14 are defined as one set, and the polarity inverting method is determined (selected) and switched every one set. This is because there is a possibility that the direct-current voltage is always applied to the liquid crystal panel when the polarity inverting method is switched between the dot inversion and the 2H dot inversion every one frame. This direct-current voltage may bring about a burn-in in the liquid crystal panel.

Here, the case of determining (selecting) the inversion driving method every one pixel block of (the 4 pixels (vertical))×(the 2 pixels (horizontal)) is explained. However, the number of the pixels of the pixel block is not limited to this example.

The 4 pixels that vertically array are determined as follows. That is, here, the driving method is determined (selected) and changed between the dot inversion driving method of the 2-line cycle and the 2H dot inversion driving method of the 4-line cycle. Thus, it is preferable to determine (select) and change the driving method at the 4m-line cycle (m is the natural number) that is the common multiple between the 2-line cycle and the 4-line cycle. The determination (selection) and change of the driving method at the 4-line cycle of the minimum common multiple of m=1 as described in this embodiment is further preferable because the deterioration in the image quality is further suppressed.

The 2 pixels that horizontally array are determined as follows. That is, the set of the two pixels adjacent to each other in the horizontal direction is designed so as to be always the multiple of the set of the polarities of “+” and “−”. Consequently, the liquid crystal can be designed so as not to be charged up. Thus, the driving method is preferably determined (selected) and changed such that it becomes 2k (k is a natural number). The determination (selection) and change of the driving method at the 2-pixel cycle of k=1 as described in this embodiment is further preferable because the deterioration in the image quality is further suppressed.

The configurations and operations of the present invention as mentioned above enable the achievement of the effect similar to the first embodiment. In addition, since the inversion driving method is determined every pixel block composed of the plurality of pixels, it is possible to properly suppress the deterioration in the image quality such as the generation of the flicker and reduce the electric power consumption and suppress the heat generation at each portion such as the data driving unit 2.

Here, the driving method of the present invention is applied to all of the pixels. However, as mentioned above, the driving method of the present invention may be applied to the pixels of the G-signal in the RGB signal, and the 2H dot inversion driving method may be applied to the remaining R-signal and B-signal. Also in this case, as compare with the case of applying the present invention to all of the pixels, it becomes easy to control the driving method, and the use of the 2H dot inversion driving method for the remaining R-signal and B-signal enables the further reduction in the electric power consumption and heat generation.

The gate driving unit 2a in the liquid crystal display device of the present invention can use the driving circuit to which the gate driving unit 2 explained in FIG. 5 is modified.

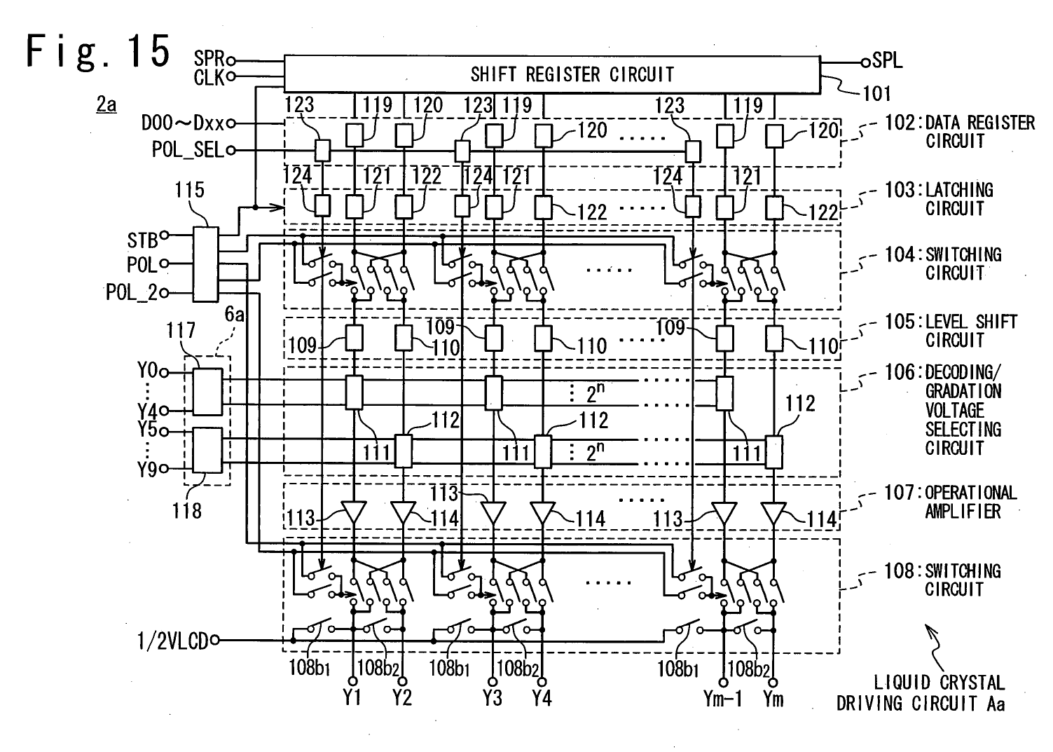

FIG. 15 is a block diagram showing the gate driving unit 2a in the liquid crystal display device of the present invention. The gate driving unit 2a includes a liquid crystal driving circuit Aa and switching circuits 104, 108.

The liquid crystal driving circuit Aa outputs plus and minus voltages, with the half voltage of the supplied liquid crystal driving voltage or the voltage Vcom of the liquid crystal common electrode as the reference, based on the applied image data. The liquid crystal driving circuit Aa includes a shift register circuit 101, a data register circuit 102, a latching circuit 103, a level shift circuit 105, a decoding/gradation voltage selecting circuit 106 and an operational amplifier 107. Those circuit configurations are composed of two systems. Incidentally, in the present invention, the voltage Vcom of the liquid crystal common electrode is used as the reference. Then, when the liquid crystal driving voltage is equal to or higher than the voltage Vcom, the plus voltage is applied as the liquid crystal driving voltage. When the liquid crystal driving voltage is lower than the voltage Vcom, the minus voltage is applied as the liquid crystal driving voltage. Then, the alternate drive is carried out by applying them while keeping the amplitude relation.

The data register circuit 102 latches in parallel the image data 21 (D00 to Dxx) of n (n is a natural number) bits to be controlled, in response to the outputs of the respective columns of the shift register circuit 101. This has the two systems. One system includes data register circuits 119. Another system includes data register circuits 120. One data register circuit 119 and one data register circuit 120 are defined as one set. The data register circuit 102 includes m sets of the data register circuits 219 and 220. The data register circuit 102 further includes register circuits 123 for storing the POL_SEL signals, for each set.

The latching circuit 103 collectively latches the n-bit data (the image data 21: D00 to Dxx) from the data register circuit 102, in response to the latch signal (hereafter, “STB Signal”). This has the two systems. One system includes latching circuits 121, each of which is connected to the data register circuit 119. Another system includes latching circuits 122, each of which is connected to the data register circuit 120. One latching circuit 121 and one latching circuit 122 are defined as one set. The latching circuit 103 includes m sets of the latching circuits 221 and 222.

The latching circuit 103 further includes register circuits 124 for storing the POL_SEL signals, for each set.

The level shift circuit 105 boosts the n-bit data from the latching circuit 103 up to the liquid crystal driving voltages of different voltage values. This has the two systems. One system includes level shift circuits 109 on a high-voltage-side. Another system includes level shift circuits 110 on a low-voltage-side. One level shift circuit 109 and one level shift circuit 110 are defined as one set. The level shift circuit 105 includes m sets of the level shift circuits 109 and 110. In this embodiment, the level shift circuit 109 on the high-voltage-side is designed, fore example, so as to boost 3.3 V up to 10 V, and the level shift circuit 110 on the low-voltage-side is designed, for example, so as to boost 3.3 V up to 5 V. However, it is not limited to this boost-up rate. The conventionally known circuit can be used as the level shift circuit 105.

A switching circuit 104 selectively connects the output of the latching circuit 121 of one system to any one of the high-voltage-side level shift circuit 109 and the low-voltage-side level shift circuit 110, based on the control signal (POL signal or POL_{—}2 signal) from a timing control circuit 115. Simultaneously, the switching circuit 104 selectively connects the output of the latching circuit 122 of the other one system to the other one of the high-voltage-side level shift circuit 109 and the low-voltage-side level shift circuit 110. Moreover, the switching circuit 104 includes a switch for selecting any one of the POL signal and the POL_{—}2 signal as the control signal, based on the POL_SEL signals accumulated in the register circuits (123, 124) for each pixel block.

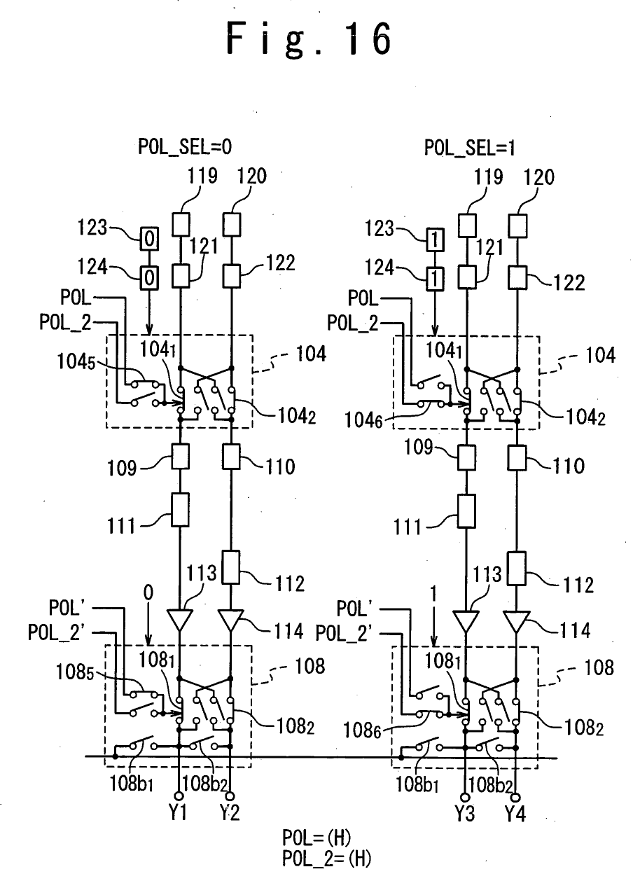

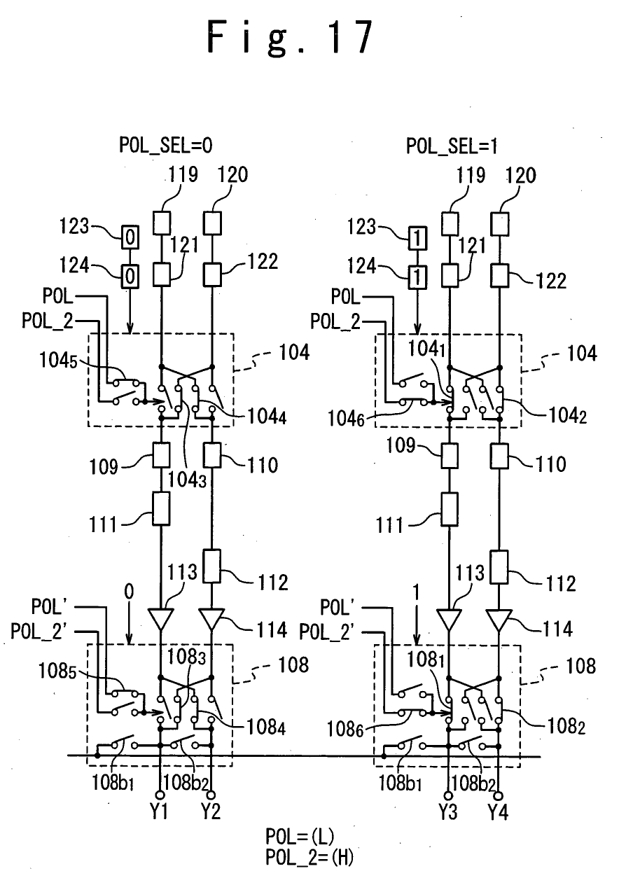

FIGS. 16 to 21 are block diagrams showing the examples of the switch controls in the respective circuits. In those Figures, one set shown in the left side indicates the case (the dot inversion driving method) that the POL signal is selected as the control signal through a contact 104₅ based on the POL_SEL signal=0. The other set shown in the right side indicates the case (the 2H dot inversion driving method) that the POL_{—}2 signal is selected as the control signal through a contact 104₆ based on the POL_SEL signal=1.

The switching circuit 104 carries out the switch controls as follows. In the left one set shown in FIG. 16, based on the POL signal=high level (H) (STB signal=L), the latching circuit 121 is connected through the contact 104₁ to the high-voltage-side level shift circuit 109, and the latching circuit 122 is connected through the contact 104₂ to the low-voltage-side level shift circuit 110, respectively.

In the right one set shown in FIG. 16, based on the POL_{—}2 signal=high level (H) (STB signal=L), the latching circuit 121 is connected through the contact 104₁ to the high-voltage-side level shift circuit 109, and the latching circuit 122 is connected through the contact 104₂ to the low-voltage-side level shift circuit 110, respectively.

In the left one set shown in FIG. 17, based on the POL signal=low level (L) (STB signal=L), the latching circuit 121 is connected through the contact 104₄ to the low-voltage-side level shift circuit 110, and the latching circuit 122 is connected through the contact 104₃ to the high-voltage-side level shift circuit 109, respectively.

In the right one set shown in FIG. 17, based on the POL_{—}2 signal=high level (H) (STB signal=L), the latching circuit 121 is connected through the contact 104₁ to the high-voltage-side level shift circuit 109, and the latching circuit 122 is connected through the contact 104₂ to the low-voltage-side level shift circuit 110, respectively.

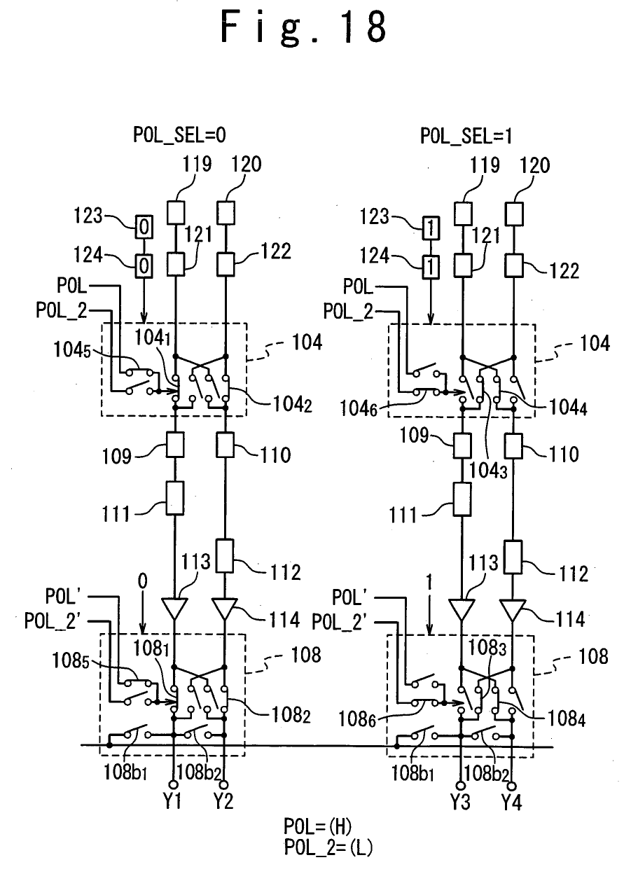

In the left one set shown in FIG. 18, based on the POL signal=high level (H) (STB signal=L), the latching circuit 121 is connected through the contact 104₁ to the high-voltage-side level shift circuit 109, and the latching circuit 122 is connected through the contact 104₂ to the low-voltage-side level shift circuit 110, respectively.

In the right one set shown in FIG. 18, based on the POL_{—}2 signal=low level (L) (STB signal=L), the latching circuit 121 is connected through the contact 104₄ to the low-voltage-side level shift circuit 110, and the latching circuit 122 is connected through the contact 104₃ to the high-voltage-side level shift circuit 109, respectively.

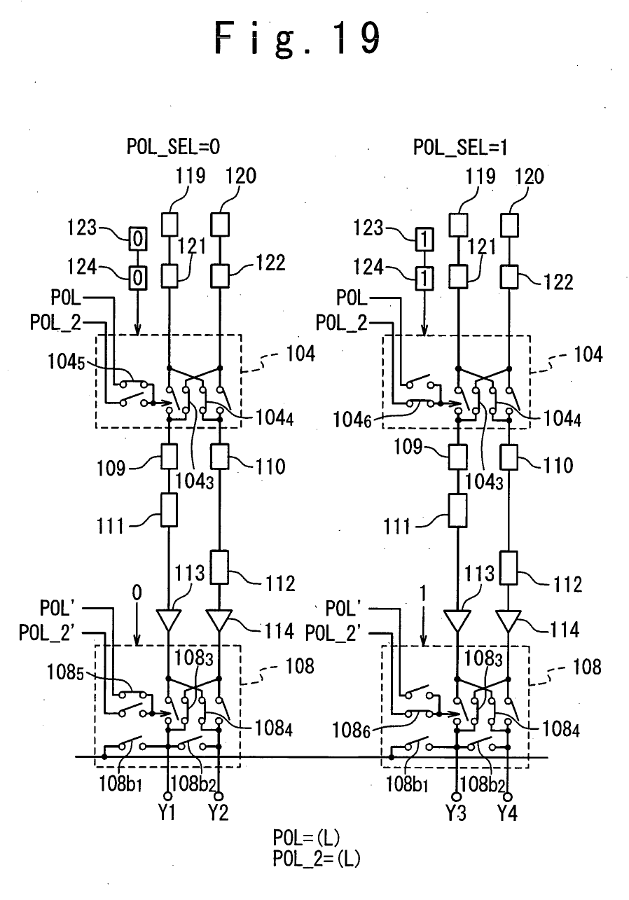

In the left one set shown in FIG. 19, based on the POL signal=low level (L) (STB signal=L), the latching circuit 121 is connected through the contact 104₄ to the low-voltage-side level shift circuit 110, and the latching circuit 122 is connected through the contact 104₃ to the high-voltage-side level shift circuit 109, respectively.

In the right one set shown in FIG. 19, based on the POL_{—}2 signal=low level (L) (STB signal=L), the latching circuit 121 is connected through the contact 104₄ to the low-voltage-side level shift circuit 110, and the latching circuit 122 is connected through the contact 104₃ to the high-voltage-side level shift circuit 109, respectively.

The gradation voltage generating circuit 6, the decoding/gradation voltage selecting circuit 106 and the operational amplifier 107 are similar to the gradation voltage generating circuit 6, the decoding/gradation voltage selecting circuit 206 and the operational amplifier 207 in the first embodiment. Thus, their explanations are omitted. Here, the high-voltage-side gradation voltage generating circuit 117 and the low-voltage-side gradation voltage generating circuit 118 correspond to the high-voltage-side gradation voltage generating circuit 217 and the low-voltage-side gradation voltage generating circuit 218, respectively. The high-voltage-side decoding/gradation voltage selecting circuit 111 and the low-voltage-side decoding/gradation voltage selecting circuit 112 correspond to the high-voltage-side decoding/gradation voltage selecting circuit 211 and the low-voltage-side decoding/gradation voltage selecting circuit 212, respectively. The high-voltage-side operational amplifier 113 and the low-voltage-side operational amplifier 114 correspond to the high-voltage-side operational amplifier 213 and the low-voltage-side operational amplifier 214, respectively.

The switching circuit 108 is shared at the two terminals of the two system circuits of the liquid crystal driving circuit Aa and outputs the plus and minus voltages to the respective terminals in time sequence and also controls the switch so as to output the voltages such that the plus and minus amplitude relation is mutually held between the two terminals. The switching circuit 108 has a common terminal switch 108b. The common terminal switch 108b commonly connects all output terminals Y1 to Ym of the liquid crystal driving circuit Aa and sets all of the output terminals Y1 to Ym to the half voltage of the liquid crystal driving voltage (½VLCD (for example: 5 V)). The withstand voltage of the switching circuit 108 directly connected to the liquid crystal is set to be two times or more of the threshold voltage value of the liquid crystal. The common terminal switch 108b shorts every horizontal direction 2 lines in order to reduce the electric power consumption. It can be independently controlled every 2 lines.

With reference to FIGS. 16 to 19, the switching circuit 108 concretely controls the switch as follows. Here, in those Figures, the left one set of the two systems indicates the case (the dot inversion driving method) that the POL signal is selected as the control signal through a contact 108₅ based on the POL_SEL signal=0. The right one set of the two systems indicates the case (the 2H dot inversion driving method) that the POL_{—}2 signal is selected as the control signal through a contact 108₆ based on the POL_SEL signal=1.

In the left one set of the two systems of FIG. 16, based on the POL signal=high level (H) (STB signal=L), the high-voltage-side operational amplifier 113 is connected through the contact 108₁ to the output terminal Y1, and the low-voltage-side operational amplifier 114 is connected through the contact 108₂ to the output terminal Y2, respectively.

In the right one set of the two systems, based on the POL_{—}2 signal=high level (H) (STB signal=L), the high-voltage-side operational amplifier 113 is connected through the contact 108₁ to the output terminal Y3, and the low-voltage-side operational amplifier 114 is connected through the contact 108₂ to the output terminal Y4, respectively.

In the left one set of the two systems of FIG. 17, based on the POL signal=low level (L) (STB signal=L), the high-voltage-side operational amplifier 113 is connected through the contact 108₄ to the output terminal Y2, and the low-voltage-side operational amplifier 114 is connected through the contact 108₃ to the output terminal Y1, respectively.

In the right one set of the two systems of FIG. 17, based on the POL_{—}2 signal=high level (H) (STB signal=L), the high-voltage-side operational amplifier 113 is connected through the contact 108₁ to the output terminal Y3, and the low-voltage-side operational amplifier 114 is connected through the contact 108₂ to the output terminal Y4, respectively.

In the left one set of the two systems of FIG. 18, based on the POL signal=high level (H) (STB signal=L) the high-voltage-side operational amplifier 113 is connected through the contact 108₁ to the output terminal Y1, and the low-voltage-side operational amplifier 114 is connected through the contact 108₂ to the output terminal Y2, respectively.

In the right one set of the two systems of FIG. 18, based on the POL_{—}2 signal=low level (L) (STB signal=L), the high-voltage-side operational amplifier 113 is connected through the contact 108₄ to the output terminal Y4, and the low-voltage-side operational amplifier 114 is connected through the contact 108₃ to the output terminal Y3, respectively.

In the left one set of the two systems of FIG. 19, based on the POL signal=low level (L) (STB signal=L), the high-voltage-side operational amplifier 113 is connected through the contact 108₄ to the output terminal Y2, and the low-voltage-side operational amplifier 114 is connected through the contact 108₃ to the output terminal Y1, respectively.

In the right one set of the two systems of FIG. 19, based on the POL_{—}2 signal=low level (L) (STB signal=L), the high-voltage-side operational amplifier 113 is connected through the contact 108₄ to the output terminal Y4, and the low-voltage-side operational amplifier 114 is connected through the contact 108₃ to the output terminal Y3, respectively.

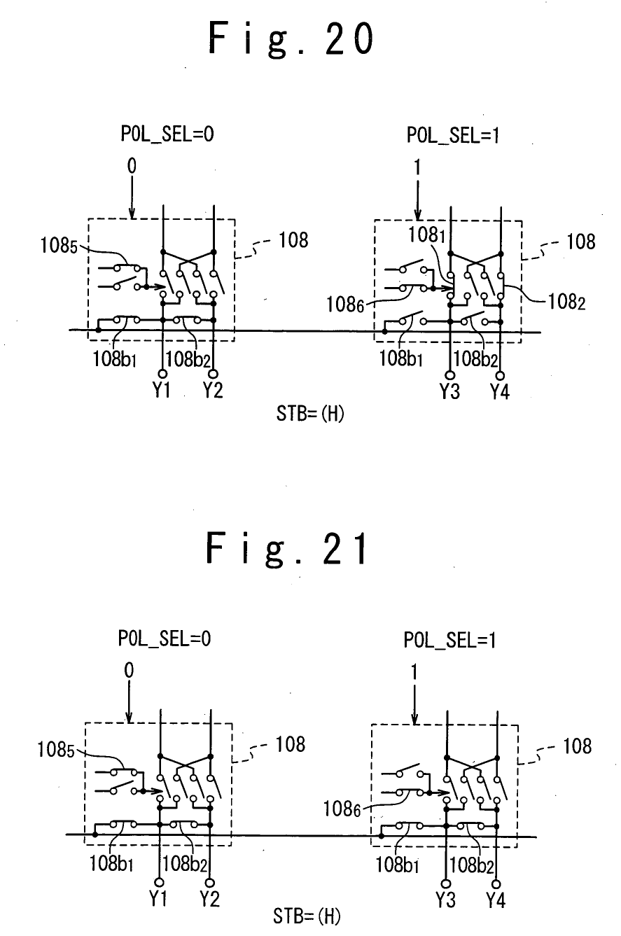

FIGS. 20, 21 are block diagrams showing the examples of the switch controls in the respective circuits. Here, in those Figures, the left one set of the two systems indicates the case (the dot inversion driving method) that based on the POL_SEL signal=0, the POL signal is selected as the control signal. The right one set of two systems the indicates the case (the 2H dot inversion driving method) that based on the POL_SEL signal=1, the POL_{—}2 signal is selected as the control signal.

With reference to FIG. 20, when the STB signal is at the high level (H), the common terminal switches 108b (contacts 108b₁, 108b₂) related to the output terminals (in FIG. 20, Y1, Y2) controlled by the POL signal are turned on in the cycle when only the POL signal is inverted. Consequently, the output terminals (in FIG. 20, Y1, Y2) controlled by the POL signal in the liquid crystal driving circuit Aa are commonly connected and set to ½VLCD. However, the common terminal switches 108b (contacts 108b₁, 108b₂) related to the output terminals (in FIG. 20, Y3, Y4) controlled by the POL_{—}2 signal are still off.

With reference to FIG. 21, when the STB signal is at the high level (H), all of the common terminal switches 108b (contacts 108b₁, 108b₂) are turned on in the cycle where the POL signal and the POL_{—}2 signal are inverted. Consequently, all of the output terminals (in FIG. 20, Y1 to Y4) in the liquid crystal driving circuit Aa are commonly connected and set to ½VLCD.

Next, as for the power source voltages of the respective circuits, the data register circuits 119, 120, the latching circuits 121, 122, the switching circuits 104, 108, the level shift circuits 109, 110, the decoding/gradation voltage selecting circuits 111, 112 and the operational amplifiers 113, 114 are similar to the data register circuits 219, 220, the latching circuits 221, 222, the switching circuits 204, 208, the level shift circuits 209, 210, the decoding/gradation voltage selecting circuits 211, 212 and the operational amplifiers 213, 214, respectively. The voltages supplied as the external inputs to the gradation voltage generating circuits 117, 118 are also similar to those of the gradation voltage generating circuits 217, 218.

With regard to the operations (the step S07 in FIG. 3) of the third embodiment in the liquid crystal display device of the present invention that uses the gate driving unit 2a of FIG. 15, the case that the image data has 6 bits (64 gradations) will be exemplified below, with reference to FIG. 13 and FIG. 16 to 22.

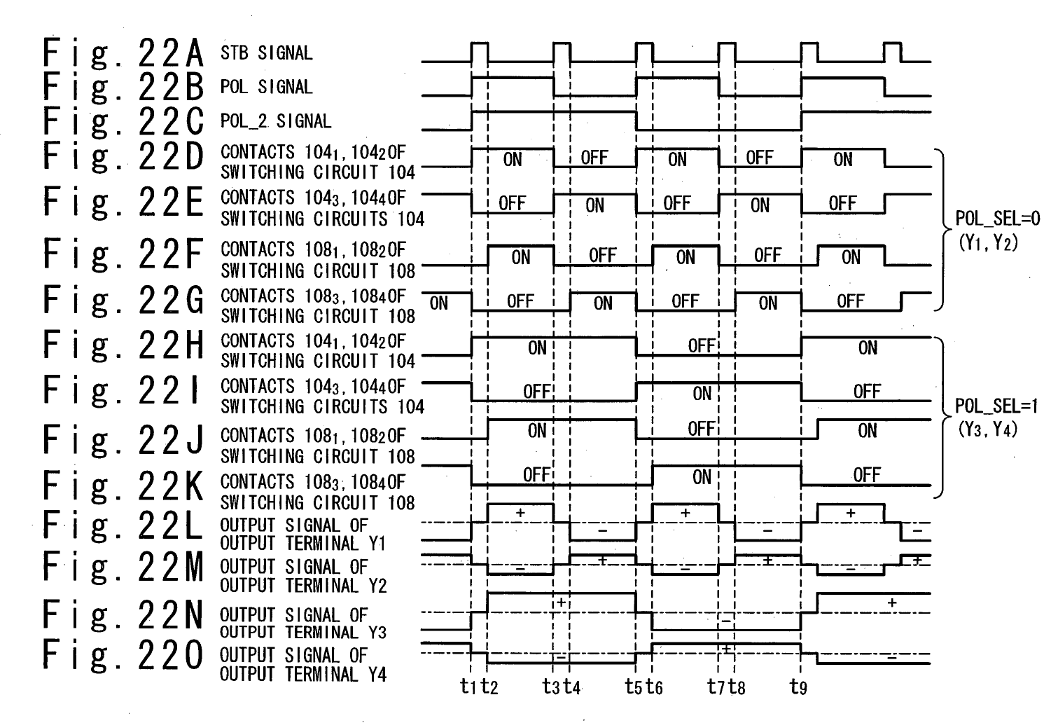

FIGS. 22A to 220 are timing charts showing the operations of the respective circuits shown in FIG. 15. FIG. 22A shows the STB signal, FIG. 22B shows the POL signal, and FIG. 22C indicates the POL_{—}2 signal, respectively.

FIG. 22D shows the on/off states of the contacts 104₁, 104₂ of the switching circuit 104. FIG. 22E shows the on/off states of the contacts 104₃, 104₄ of the switching circuits 104. FIG. 22F shows the on/off states of the contacts 108₁, 108₂ of the switching circuit 108. FIG. 22G shows the on/off states of the contacts 108₃, 108₄ of the switching circuit 108. Here, FIGS. 22D to 22G are the case of the line of the POL_SEL signal=0 (the dot inversion driving method).

FIG. 22H shows the on/off states of the contacts 104₁, 104₂ of the switching circuit 104. FIG. 22I shows the on/off states of the contacts 104₃, 104₄ of the switching circuits 104. FIG. 22J shows the on/off states of the contacts 108₁, 108₂ of the switching circuit 108. FIG. 22K shows the on/off states of the contacts 108₃, 108₄ of the switching circuit 108. Here, FIGS. 22H to 22K are the case of the line of the POL_SEL signal=1 (the 2H dot inversion driving method).

FIG. 22L shows the output signal of the output terminal Y1, FIG. 22M shows the output signal of the output terminal Y2, FIG. 22N shows the output signal of the output terminal Y3, and FIG. 220 shows the output signal of the output terminal Y4, respectively.

Based on the POL signal, POL_{—}2 signal and STB signal which are supplied to the timing control circuit 115, and the POL_SEL signal supplied to the data register circuit 102, the switching circuit 104 and the switching circuit 108 are switched alternately (Y1, Y2) for each line, or alternately (Y3, Y4) for each 2 lines, as shown in FIGS. 16 to 19 and 22A to 220. Thus, on the basis of which one of systems the image data of the 64 gradations passes through in the liquid crystal driving circuit Aa, the plus and minus voltages are alternately applied to the liquid crystal electrode at the predetermined cycle.

Also, as shown in FIG. 21 and FIGS. 22A to 220, in a period where the STB signal supplied to the timing control circuit 115 is at the high level (H), the contacts 108₁, 108₂, 108₃ and 108₄ are turned off by the switch control of the switching circuit 108, and the contacts 108b₁, 108b₂ are turned on. Then, all of the output terminals Y1 to Ym of the liquid crystal driving circuit Aa are reset to the half voltage of the liquid crystal driving voltage (for example, 5 V).

Also, since any one of the POL signal and the POL_{—}2 signal is selected for each pixel block based on the POL_SEL signal, the pixel block of the liquid crystal panel 4 is driven by any one method of the dot inversion driving method and the 2H dot inversion driving method.

The operations will be described below in further detail. Let us suppose that the data register circuit 119 connected to the output terminal Y1 of the liquid crystal driving circuit Aa holds the data of a usually low level (L) (the image data whose gradation is constant), and the data register circuit 120 connected to the output terminal Y2 of the liquid crystal driving circuit Aa holds the data of a usually high level (H) (the image data whose gradation is constant).

(A) The Dot Inversion Driving Method

At the step S02 of FIG. 3, if it is judged that in the input image data 28 of the pixel block of (the 4 pixels)×(the 2 pixels), there are the predetermined number or more of the pixels, in which the image data has the gradation of the setting gradation or higher, the dot inversion driving method is determined (selected) as the driving method. In that case, the POL_SEL signal=0. Then, the operations are carried out, as indicated on the sides of the output terminals Y1, Y2 and as shown in FIGS. 22A, 22B and 22D to 22G and 22L, 22M.

Based on the polarity inversion switching control signal 26 (POL_SEL signal=0) outputted by the LCD control unit 5a, the switching circuit 104 selects the POL signal through the contact 104₅, and the switching circuit 108 selects the POL signal through the contact 108₅.

(1) t=t1 to t3 (Corresponds to the Cases of the Left Sides of FIGS. 16, 18)

When the POL signal (FIG. 22B) supplied to the timing control circuit 115 is at the high level (H) (t=t1), based on the high level (H) of the STB signal (FIG. 22A), the contacts 108₁, 108₂ (FIG. 22F) and 108₃, 108₄ (FIG. 22G) of the switching circuit 108 are turned off. On the other hand, the contacts 108b₁, 108b₂ (not shown in FIGS. 22A to 220, and refer to the left sides of FIGS. 20, 21) are turned on.

At this time, in one of the two systems, the contact 104₁ (FIG. 22D) of the switching circuits 104 is turned on, and the contact 104₄ (FIG. 22E) is turned off. Thus, the data of the low level (L) held by the data register circuit 119 is transferred from the latching circuit 121 through the switching circuits 104 to the level shift circuit 109. The gradation voltage 10 V is selected by the decoding/gradation voltage selecting circuit 111 and current-amplified by the operational amplifier 113. Then, when the STB signal (FIG. 22A) is switched to the low level (t=t2), the contact 108₁ (FIG. 22F) of the switching circuit 108 is turned on, and the contacts 108b₁, 108b₂ (not shown) are turned off. Hence, the image data is outputted through the switching circuit 108 to the output terminal Y1 (FIG. 22L) of the liquid crystal driving circuit Aa. Then, the gradation voltage 10 V (the polarity is plus “+”) of the predetermined voltage value is applied to the liquid crystal panel 4.

In the other of the two systems, the contact 104₂ (FIG. 22D) of the switching circuits 104 is turned on, and the contact 104₃ (FIG. 22E) is turned off. Thus, the data of the high level (H) held by the data register circuit 120 is transferred from the latching circuit 122 through the switching circuit 104 to the level shift circuit 110. The gradation voltage 4.5 V is selected by the decoding/gradation voltage selecting circuit 112 and current-amplified by the operational amplifier 114. Then, when the STB signal (FIG. 22A) is switched to the low level (t=t2), the contact 108₂ (FIG. 22F) of the switching circuit 108 is turned on, and the contacts 108₁, 108b₂ (not shown) are turned off. Hence, the image data is outputted through the switching circuit 108 to the output terminal Y2 (FIG. 22M) of the liquid crystal driving circuit Aa. Then, the gradation voltage 4.5 V (the polarity is minus “−”) of the predetermined voltage value is applied to the liquid crystal panel 4.

(2) t=t3 to t5 (Corresponds to the Cases of the Left Sides of FIGS. 17, 19)

When the POL signal (FIG. 22B) supplied to the timing control circuit 115 is at the low level (L) (t=t3), based on the high level of the STB signal (FIG. 22A), the contacts 108₁, 108₂ (FIG. 22F) and 108₃, 108₄ (FIG. 22G) of the switching circuit 108 are turned off. On the other hand, the contacts 108b₁, 108b₂ (not shown in FIGS. 22A to 220, and refer to the left sides of FIGS. 20, 21) are turned on.

At this time, in one of the two systems, the contact 104₁ (FIG. 22D) of the switching circuits 104 is turned off, and the contact 104₄ (FIG. 22E) is turned on. Thus, the data of the low level (L) held by the data register circuit 119 is transferred from the latching circuit 121 through the switching circuits 104 to the level shift circuit 110. The gradation voltage 10 V is selected by the decoding/gradation voltage selecting circuit 112 and current-amplified by the operational amplifier 114. Then, when the STB signal (FIG. 22A) is switched to the low level (t=t4), the contact 108₃ (FIG. 22G) of the switching circuit 108 is turned on, and the contacts 108b₁, 108b₂ (not shown) are turned off. Thus, the image data is outputted through the switching circuit 108 to the output terminal Y1 (FIG. 22L) of the liquid crystal driving circuit Aa. Then, the gradation voltage 10 V (the polarity is minus “−”) of the predetermined voltage value is applied to the liquid crystal panel 4.

In the other of the two systems, the contact 104₂ (FIG. 22D) of the switching circuits 104 is turned off, and the contact 104₃ (FIG. 22E) is turned on. Thus, the data of the high level (H) held by the data register circuit 120 is transferred from the latching circuit 122 through the switching circuits 104 to the level shift circuit 109. The gradation voltage 4.5 V is selected by the decoding/gradation voltage selecting circuit 111 and current-amplified by the operational amplifier 113. Then, when the STB signal (FIG. 22A) is switched to the low level (t=t4), the contact 108₄ (FIG. 22G) of the switching circuit 108 is turned on, and the contacts 108b₁, 108b₂ are turned off. Thus, the image data is outputted through the switching circuit 108 to the output terminal Y2 (FIG. 22M) of the liquid crystal driving circuit Aa. Then, the gradation voltage 4.5 V (the polarity is plus “+”) of the predetermined voltage value is applied to the liquid crystal panel 4.

(B) The 2H Dot Inversion Driving Method

At the step S02 of FIG. 3, if it is judged that in the input image data 28 of the pixel block of (the 4 pixels)×(the 2 pixels), there are not the predetermined number or more of the pixels, in which the image data has the gradation of the setting gradation or higher, the 2H dot inversion driving method is determined (selected) as the driving method. In that case, the POL_SEL signal=1. Then, the operations are carried out, as indicated on the sides of the output terminals Y3, Y4 and as shown in FIGS. 22A, 22C, 22H to 22K, 22N and 220.

Based on the polarity inversion switching control signal 26 (POL_SEL signal=1) outputted by the LCD control unit 5a, the switching circuit 104 selects the POL_{—}2 signal through the contact 104₆, and the switching circuit 108 selects the POL_{—}2 signal through the contact 108₆.

At t=t1 to t5, in the period corresponding to the two cycles of the STB signal, the POL_{—}2 signal becomes constant at the plus “+” (corresponds the cases of the right sides of FIGS. 16, 17). On the other hand, at t=t5 to t9, the POL_{—}2 signal becomes constant at the minus “−” (corresponds to the cases of the right sides of FIGS. 18, 19). That is, this becomes the 2H dot inversion driving method in which the polarity is inverted every two cycles of the STB signal.

The operations of the respective circuits are similar to those in the case of the dot inversion, except that the timings are different (the timing charts of the respective contacts of the switching circuits 104, 108: (h) to (k), the timing charts of the output terminals Y3, Y4: (n), (o)). Thus, their explanations are omitted.

Since the data driving unit 2a has the two system circuits of the low-voltage-side and the high-voltage-side, the use of the data driving unit 2a as shown in FIG. 15 results in the smaller width of the voltage to be handled in one system, as compared with the case where the one system circuit is used to cope with the voltage that is equal to or greater than two times the threshold voltage of the liquid crystal. That is, it is possible to reduce the electric power consumption while suppressing the deterioration in the image quality and to make the withstand voltage of each circuit lower.

In the first embodiment, the inversion driving method of the polarity is changed for each of the plurality of gate lines. However, it is possible to change the inversion driving method of the polarity for each of the plurality of data lines. For example, this can be carried out by using the data driving unit 2a in the third embodiment and using the line memory 13 corresponding to one frame.

It is apparent that the present invention is not limited to the above embodiment, that may be modified and changed without departing form the scope and spirit of the invention.

What is claimed is:

1. A liquid crystal display device comprising:
a controlling unit configured to control a liquid crystal panel,
wherein said controlling unit includes:
an image judging unit configured to compare a gradation of each pixel of image data with a reference gradation, and
a method determining unit configured to determine an inversion driving method for displaying said image data on said liquid crystal panel every plurality of pixels of less than one frame in said image data as a selection inversion driving method, based on said comparison result.

2. The liquid crystal display device according to claim 1, wherein said reference gradation is set at a boundary between a gradation in which an image on said liquid crystal panel is easy to be deteriorated and a gradation in which an image on said liquid crystal panel is hard to be deteriorated.

3. The liquid crystal display device according to claim 1, wherein said image deterioration is a generation of a flicker.

4. The liquid crystal display device according to claim 1, wherein said plurality of pixels is pixels included in the horizontal lines whose number is a common multiple between a number of first horizontal lines corresponding to one first inversion cycle in an inversion driving method for a gradation voltage less than that of said reference gradation and a number of second horizontal lines corresponding to one second inversion cycle in an inversion driving method for a gradation voltage equal to and more than that of said reference gradation.

5. The liquid crystal display device according to claim 1, wherein said method determining unit determines a dot inversion driving method as an inversion driving method for said plurality of pixels in said image data when a number of pixels whose gradation voltage less than that of said reference gradation in said plurality of pixels is equal to or more than n, and
said n is a natural number less than a number of said plurality of pixels.

6. The liquid crystal display device according to claim 5, wherein said method determining unit determines a 2H or more dot inversion driving method as an inversion driving method for said plurality of pixels in said image data when a number of pixels whose gradation voltage less than that of said reference gradation in said plurality of pixels is less than said n.

7. The liquid crystal display device according to claim 1, further comprising:
a data driving unit configured to control outputs corresponding to said image data to data lines of said liquid crystal panel such that said liquid crystal panel displays said image data by using said selection inversion driving method,
wherein said controlling unit outputs a selection signal indicating said selection inversion driving method to said data driving unit, and
said data driving unit includes an inversion switching unit configured to invert a polarity of said outputs corresponding to said image data to said data lines at a timing of an inversion of a polarity in said selection inversion driving method based on said selection signal.

8. The liquid crystal display device according to claim 7, wherein said data driving unit further includes:
a first switching unit configured to select one of a first system of circuit and a second system of circuit as a selection system circuit for a path of said image data,
a first level shifting unit configured to shift a voltage of said image data to that in a first voltage range with a first polarity in said first system of circuit,
a second level shifting unit configured to shift said voltage of said image data to that in a second voltage range with a second polarity lower than said first voltage range in said second system of circuit, and
a second switching unit configured to select one of a first terminal of said first system and a second terminal of said second system such that outputs from said selection system circuit are outputted from a terminal corresponding to said image data,
wherein said data driving unit controls said selections by said first and second switching units at the timing of the inversion of the polarity in said selection inversion driving method based on said selection signal.

9. The liquid crystal display device according to claim 1, wherein said method determining unit determine said inversion driving method every 2m frame based on said comparison result, said m is a natural number.

10. A method for driving a liquid crystal display device, comprising:
(a) comparing a gradation of each pixel of image data with a reference gradation;
(b) determining an inversion driving method for displaying said image data on said liquid crystal panel every plurality of pixels of less than one frame in said image data as a selection inversion driving method, based on said comparison result; and
(c) displaying said image data by using said selection inversion driving method.

11. The method for driving a liquid crystal display device according to claim 10, wherein said step (b) includes:
(b1) outputting a selection signal indicating said selection inversion driving method, said step (c) includes:
(c1) inverting a polarity of said outputs corresponding to said image data to said data lines at a timing of an inversion of a polarity in said selection inversion driving method based on said selection signal.

12. The method for driving a liquid crystal display device according to claim 11, wherein said step (c1) includes:
(c11) shifting a voltage of said image data to that in one of a first voltage range with a first polarity and a second voltage range with a second polarity lower than said first voltage range, and
(c12) outputting said voltage-shifted image data to an output terminal corresponding to said voltage-shifted image data.

13. The method for driving a liquid crystal display device according to claim 10, wherein said reference gradation is set at a boundary between a gradation in which a flicker is easy to see and a gradation in which the flicker is hard to see.

14. The method for driving a liquid crystal display device according to claim 10, wherein said plurality of pixels is pixels included in the horizontal lines whose number is a common multiple between a number of first horizontal lines corresponding to one first inversion cycle in an inversion driving method for a gradation voltage less than that of said reference gradation and a number of second horizontal lines corresponding to one second inversion cycle in an inversion driving method for a gradation voltage equal to and more than that of said reference gradation.

15. The method for driving a liquid crystal display device according to claim 10, wherein said step (b) includes:
(b2) determining a dot inversion driving method as an inversion driving method for said plurality of pixels in said image data when a number of pixels whose gradation voltage less than that of said reference gradation in said plurality of pixels is equal to or more than n,
wherein said n is a natural number less than a number of said plurality of pixels.

16. The method for driving a liquid crystal display device according to claim 15, wherein said (b) includes:
(b3) determining a 2H or more dot inversion driving method as an inversion driving method for said plurality of pixels in said image data when a number of pixels whose gradation voltage less than that of said reference gradation in said plurality of pixels is less than said n.

17. The method for driving a liquid crystal display device according to claim 10, wherein said step (b) includes:
(b4) determining said inversion driving method every 2m frame based on said comparison result, said m is a natural number,
said step (c) includes:
(c2) displaying said image data by using said selection inversion driving method every 2m frame.
